(19) United States
(12) Patent Application Publication
(10) Pub. No.: US 2007/0081115 A1
(43) Pub. Date: Apr. 12, 2007

(54) Polarizing plate and image display device using the same

(75) Inventors: Minoru Wada, Minami-ashigara-shi (JP); Shigeaki Nimura, Minami-ashigara-shi (JP); Satoshi Sanada, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/492,984

(22) Filed: Jul. 26, 2006

(30) Foreign Application Priority Data
Jul. 27, 2005 (JP) 217242/2005

(51) Int. Cl. G02F 1/1335

(52) U.S. Cl. 349/96

(57) ABSTRACT

An image display device comprising a panel including a substrate, a foreside laminated body arranged on the viewer side of the substrate, and a backside laminated body arranged on the opposite side of the substrate, wherein the foreside laminated body comprises a polarizer, a viewer side protective film and a substrate side protective film having a thickness thinner than that of the viewer side protective film by 10 μm or more. The device suppresses lowering in display performance by preventing warpage of the panel.

### BACKGROUND OF THE INVENTION

1. Field of the Invention

The present invention relates to a polarizing plate and an image display device such as a flat panel display using the same. In particular, the invention relates to an image display device as a liquid crystal display device used for a monitor of a personal computer or a television.

2. Description of the Related Art

Recently, various types of image display devices such as a liquid crystal display device, an organic EL display device and a PDP have been developed. The application of these ranges widely and, recently, development is proceeding from the application for a monitor of a personal computer, further, to the application for TV. Along with this, development of a large size screen proceeds. As well as a large size screen, reducing the thickness of a whole image display device also proceeds to results in such problem that warpage of a panel having a thin glass or resin substrate constituting an image display device easily generates, that is, the center portion dishes and the fringe portion warpages to the foreside, when viewed from the foreside (viewerside). When such warpage generates, the ringe portion, or four corners of a panel may contact to a housing, which gives an adverse affect on picture display performance.

Warpage of a panel is caused by disruption of a balance of forces between fore- and back-sides of an image display device due to generation of difference between the fore- and back-sides resulting from expansion/contraction of various types of members laminated on both sides of a glass or resin substrate relative to the substrate, which does not generate warpage in nature, through heating or moisture absorption/desorption. In an ordinary image display device, the foreside face is opened, but the backside face is assembled in a housing to become in a quasi sealed state. Consequently, difference generates in heating and moisture absorption/desorption between the foreside laminated body and the backside laminated body to result in generation of difference in expansion/contraction, too.

Taking a liquid crystal display device for an example, a liquid crystal display device is manufactured by arranging a polarizing plate for producing polarized light on both sides of a liquid cell in which liquid crystal is sealed between glass substrates, laminating various optical elements such as a retardation plate, an antireflection film or a brightness-enhancing film according to need, fixing the periphery thereof with a fixing frame composed of a metallic plate such as stainless steel plate, which is called a “bezel”, to form a liquid crystal module, assembling and housing the liquid crystal module with other constitutional elements in a housing.

According to such reason that, when a light source switch of a liquid crystal display device is on, temperature rises due to a backlight, sometimes difference in temperature or humidity may generate between the foreside (viewer side) and the backlight side. In this case, it is considered that temperature or humidity conditions to which the foreside laminated body including a polarizing plate and the backlight side laminated body are exposed respectively are different, while taking the liquid cell as a boundary, and that respective laminated bodies are subjected to the influence. When warpage generates, the fringe portion or 4 corners of a panel not only contact to the housing, but also stick fast to the backlight arranged on the backside to generate display performance problems. Further, a “corner unevenness” phenomenon in which light leaks unevenly from 4 corners of a panel (screen) when the screen is in black level of display, which some times causes a very large problem in display performance.

In order to improve warpage of a panel due to environmental alteration, in JP-A-2003-149634, in a liquid crystal display device prepared by arranging a polarizing plate composed of a polarizer with a protective film on both sides of a liquid crystal cell and further laminating a brightness enhancing film to the backside polarizing plate, thicknesses of the protective film used for the foreside polarizing plate and the protective film used for the backside polarizing plate are set to be not equal. However, when the protective film of the laminated body on the viewer side arranged on the foreside is thinned, there was such problem that the polarizer tends to easily deteriorate due to humidity to lower optical performances.

### SUMMARY OF THE INVENTION

Consequently, the present inventors considered to solve such conventional problems, and aimed in the present invention to provide an image display device in which warpage of a panel of an image display device is prevented and lowering in display performance is suppressed. In addition, the present inventors also aimed in the invention to provide apolarizing plate capable of preventing warpage of a panel when assembled in an image display device, thereby suppressing lowering in display performance.

The present inventors found that, when a liquid crystal display device having been left under a high temperature and high humidity for a certain period is taken out under ordinary temperature and humidity, in particular the foreside laminated member, which had been exposed more strongly to a high temperature and humidity, contracts to lead to disruption of balance of power between the fore- and back-sides of the panel to generate warpage, and that the contraction of the foreside laminated member is mainly caused by contraction of the polarizer constituting the foreside laminated member.

As the result of further investigation, the present inventors found that, in order to prevent warpage, it is effective to set the thickness of a protective film on the viewer side of the foreside polarizer to be thick for the purpose of suppressing contraction of a polarizer, and to set the thickness of a protective film on the substrate side of the foreside polarizer to be thin to close the polarizer to the substrate for the purpose of suppressing the moment of warpage.

More specifically, the problem was solved according to the following technique.

[1] Apolarizing plate comprising apolarizer and at least one each protective film on both sides of the polarizer, wherein the total thickness of the protective film provided on one side of the polarizer is thinner than the total thickness of the protective film provided on the opposite side of the polarizer by 10 μm or more.

[2] A polarizing plate comprising a polarizer, one protective film on one side of the polarizer, and at least one protective film on the opposite side of the polarizer, wherein the thickness of the one protective film provided on the one side of the polarizer is thinner than the total thickness of the protective film provided on the opposite side of the polarizer by 10 μm or more.

[3] The polarizing plate described in [1] or [2], wherein at least one of the protective films constituting the polarizing plate comprises cellulose acylate.

[4] The polarizing plate described in [3], wherein the cellulose acylate has a structure in which some or all hydroxyl groups of glucose units constituting cellulose are substituted by at least one acyl group having 2 or more carbon atoms, and satisfies the following formulae (1) and (2):
2.0≦DS₂+DS₃+DS₆≦3.0 Formula (1):
DS₆/ (DS₂+DS₃+DS₆)≧0.315 Formula (2):
wherein DS₂ represents the substitution degree of hydrogen atom of 2-hydroxyl group in the glucose units by the acyl group; DS₃ represents the substitution degree of hydrogen atom of 3-hydroxyl group in the glucose units by the acyl group; and DS₆ represents the substitution degree of hydrogen atom of 6-hydroxyl group in the glucose units by the acyl group.

[5] The polarizing plate described in [4], wherein the acyl group is an acetyl group.

[6] The polarizing plate described in [3], wherein the protective film comprising cellulose acylate contains a mixed fatty acid ester of cellulose as a primary polymer component, wherein the mixed fatty acid ester of cellulose has a structure in which some or all hydroxyl groups of cellulose are substituted by an acetyl group and at least one acyl group having 3 or more carbon atoms, and satisfies the following formulae (3) and (4):
2.0≦A+B≦3.0 Formula (3):
0<B Formula (4):
wherein A represents the substitution degree for the acetyl group; and B represents the substitution degree for the acyl group having 3 or more carbon atoms.

[7] The polarizing plate described in [6], wherein the acyl group having 3 or more carbon atoms is a propionyl group and/or a butanoyl group.

[8] The polarizing plate described in [6] or [7], wherein the substitution degree of hydrogen atom of 6-hydroxyl group in the cellulose units of the cellulose acylate is 0.75 or more.

[9] The polarizing plate described in [1] or [2], wherein at least one of protective films constituting the polarizing plate comprises a cyclic polyolefin.

[10] The polarizing plate described in any of [1] to [9], wherein the total thickness of the protective film on one side of the polarizer is 30 μm-50 μm, and the total thickness of the protective filmonthe opposite side of thepolarizer is 70 μm-150 μm.

[11] An image display device comprising a panel including a substrate containing glass or resin, a foreside laminated body arranged on the viewer side of the substrate, and a backside laminated body arranged on the opposite side of the substrate,

where in the foreside laminated body is the polarizing plate described in any of [1] to [10] in which the total thickness of the protective film arranged on the substrate side of the polarizer is thinner than the total thickness of the protective film arranged on the viewer side of the polarizer by 10 μm or more.

[12] The image display device described in [11], wherein the panel has an oblong or square shape with a side of 10 cm-500 cm.

[13] The image display device described in [11] or [12], wherein the foreside surface of the panel is opened and the backside of the panel is closed by a housing.

[14] The image display device described in any of [11] to [13], wherein the substrate includes a liquid crystal cell, and the backside laminated body includes an optical compensatory film.

[15] The image display device described in any of [11] to [14], wherein the device utilizes liquid crystal display mode of a VA system or an IPS system is used.

Since the image display device of the invention has suppressed warpage of the panel, it can maintain an excellent display performance. Further, when the polarizing plate of the invention is assembled in an image display device, it is possible to suppress warpage of the panel and maintain an excellent display performance.

### BRIEF DESCRIPTION OF THE DRAWING

FIG. 1 is a cross-sectional view showing a constitution example of the image display device of the invention (the upper side is the viewer side). (A) denotes foreside laminated body, (B) denotes substrate, (C) denotes backside laminated bodyand(D) denotes housing.

### BEST MODE FOR CARRYING OUT THE INVENTION

The contents of the invention are described in detail hereinunder. Hereinafter, the polarizing plate and the image display device of the invention will be described in detail. The following description about the constituent features may be described on the basis of a representative embodiment of the invention, but the invention is not intended to be restricted to such embodiment. In this description, the numerical range expressed by the wording “a number to another number” and “a number—another number” mean the range that falls between the former number indicating the lowermost limit of the range and the latter number indicating the uppermost limit thereof. Further, in the description, “parallel” means that an angle formed between 2 directions is 0°±1°, and “perpendicular” and “orthogonal” mean that an angle formed between 2 directions is 90°±1°.

(Constitution of an Image Display Device)

The image display device of the invention comprises a panel including a substrate containing glass or resin, a foreside laminated body arranged on the viewer side of the substrate, and a backside laminated body arranged on the opposite side of the substrate. The foreside laminated body includes a polarizing plate, a viewer side protective film arranged on the viewer side of the polarizing plate, and a substrate side protective film arranged on the opposite side of the polarizing plate. There is such characteristic that the thickness of the substrate side protective film is thinner than the thickness of the viewer side protective film by 10 μm or more.

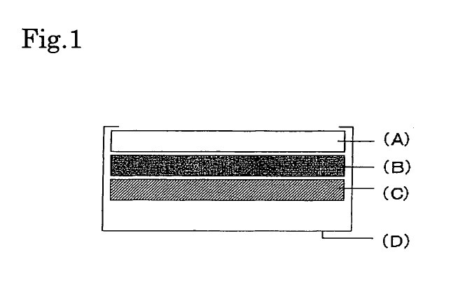

The panel constituting the image display device of the invention may be arranged with other optical films or functional layers according to need. Further, preferably the panel has an opened foreside surface, and abackside closed with a housing. A constitution example of such image display device of the invention is shown in FIG. 1 (in which the upper side is a viewer side)

In the following description, a liquid crystal display device is used as a main example of an image display device. However, the image display device of the invention is not restricted to a liquid crystal display device.

A liquid crystal display device has such construction that polarizing plates are arranged on both sides of a liquid crystal cell tobea substrate, and that various types of optical elements such as a retardation film, an antireflection film and a brightness enhancing film are laminated according to need. The substrate referred to in the invention corresponds to a liquid crystal cell in the case of a liquid crystal display device, and the laminated body corresponds to various optical elements such as a polarizing plate, a retardation film, an antireflection film and a brightness enhancing film.

Generally, the liquid crystal display device is manufactured by fixing the periphery of a liquid crystal panel with a fixing frame composed of a metallic plate such as stainless steel plate, which is called a “bezel,” to form a liquid crystal module, and assembling and housing the liquid crystal module along with other constitutional elements in a housing. It is used in a similar constitution in the invention.

(Substrate)

The substrate constituting the image display device of the invention is composed of glass or resin (plastic). The glass or resin may include an additive, and the substrate may hold an constitutional element other than the glass or resin. A “substrate” used in the invention means a plate holding liquid crystal in the case of a liquid crystal display device, and a plate holding a light emitter in the case of an organic EL display device and a PDP.

For example, when the substrate is a liquid crystal cell of a liquid crystal display device, glass or resin that is ordinarily used for this application can be adopted as a constitutional element. Then, between cell substrates composed of glass or resin, liquid crystal can be sealed. A transparent conductive film can be arranged on both faces of the liquid crystal and, further, a color filter can be arranged on the foreside (viewer side) of the transparent conductive film. From the viewpoint of reducing the thickness of a liquid crystal display device, the substrate has a thickness of preferably 1 mm or less, more preferably 0.7 mm or less, and most preferably 0.5 mm or less. There is noparticular restriction on the size, but, since warpage easily generates when a liquid crystal panel has a wide area, in particular, use of the invention for a liquid crystal display device having a large screen is effective.

Here, as to a resin substrate, material is not particularly restricted, and all the conventionally publicly known materials can be used when they have transparency and mechanical strength. Examples of the resin forming the resin substrate include thermoplastic resin such as polycarbonate, polyarylate, polyether sulfone, polyester, polysulfone, polymethyl methacrylate, polyetherimide and polyamide, and thermosetting resin such as epoxy-based resin, unsaturated polyester, polydiallyl phthalate and polyisobornyl methacrylate. One or more kinds of the resins may be used. A copolymer with other monomer and a mixture with other ingredient may be used.

(Polarizing Plate)

Next, description will be given about a polarizing plate constituting a laminated body in a liquid crystal display device.

The polarizing plate of the invention is used in the foreside laminated body of the liquid crystal display device of the invention. The polarizing plate of the invention is a polarizing plate arranged with at least each one protective film on both sides of the polarizer, characterized in that the total thickness of the protective film arranged on one side of the polarizer has a thickness thinner than the total thickness of the protective film arranged on the opposite side of the polarizer by 10 μm or more. Among these, preferable one is a polarizing plate characterized by being a polarizing plate arranged with one protective film on one side of a polarizer and arranged with at least one protective filmon the opposite side of the polarizer, wherein the thickness of the one protective film arranged on the one side of the polarizer is thinner than the total thickness of the protective film arranged on the opposite side of the polarizer by 10 μm or more.

In the polarizing plate of the invention, the total thickness of the protective film arranged on one side of the polarizer is thinner than the total thickness of the protective film arranged on the opposite side of the polarizer preferably by 20 μm or more, and more preferably by 30 μm or more. Further, the total thickness of the protective film arranged on one side of the polarizer is preferably 50 μm or less, and particularly preferably 30 μm-40 μm. In this case, the total thickness of the protective film arranged on the opposite side of the polarizer is preferably 70 μm or more, and particularly preferably 80 μm-150 μm.

As the polarizing plate constituting the liquid crystal display device of the invention, an absorption type polarizing plate, which is manufactured, for example, by laminating a polarizer prepared by soaking a polyvinyl alcohol (PVA) film with iodine having dichroic property or a dichroic dye, stretching it to align followed by cross-linking and drying, and a protective film such as a triacetylcellulose (TAC) film, can be preferably used. As a polarizer, one having an excellent optical transmittance and polarization degree is preferable. The optical transmittance is preferably 30%-50%, more preferable 35%-50%, and most preferably 40%-50%. The polarization degree is preferably 90% or more, more preferably 95% or more, and most preferably 99% or more. A transmittance of 30% or less, or a polarization degree of 90% or less results in a low brightness or contrast of an image display device, which lowers display quality level. The thickness of the polarizer is preferably 1-50 μm, more preferably 1-30 μm, and most preferably 8-25 82 m.

In the invention, adhesion treatment of the polarizer and the protective film is not particularly restricted, and can be carried out through, for example, an adhesive composed of vinyl alcohol-based polymer, or an adhesive at least composed of a water-soluble cross-linking agent of vinyl alcohol-based polymer such as boric acid or borax, glutaraldehyde or melamine, or oxalic acid. In particular, from the viewpoint of the best adhesiveness with a polyvinyl alcohol-based film, use of a polyvinyl alcohol-containing adhesive is preferable. Such adhesive layer can be formed as a coated and dried layer of an aqueous solution, or the like. When the aqueous solution is prepared, other additives and a catalyst such as an acid may be blended according to need.

As the material forming the protective film, a polymer excellent in optical performance, transparency, mechanical strength, thermal stability, moisture-blocking performance, isotropy and the like is preferable. For example, polycarbonate-based polymers, polyester-based polymers such as polyethylene terephthalate and polyethylene naphthalate, acrylic polymers such as polymethyl methacrylate, and styrene-based polymers such as polystyrene and acrylonitrile-styrene copolymer (AS resin) can be mentioned. Further, the example includes polyolefins such as polyethylene and polypropylene, polyolefin based-polymers such as ethylene-propylene copolymer, vinyl chloride-based polymers, amide-based polymers such as nylons and aromatic polyamides, imide-based polymers, sulfone-based polymers, polyether sulfone-based polymers, polyether ether ketone-based polymers, polyphenylene sulfide-based polymers, vinylidene chloride-based polymers, vinyl alcohol-based polymers, vinyl butyral-based polymers, arylate-based polymers, polyoxymethylene-based polymers, epoxy-based polymers, and polymer mixtures of above-mentioned polymers. Further, the protective film used in the invention may be also formed as a hardened layer of an ultraviolet ray-setting type or a thermosetting type resin such as acrylic, urethane-based, acrylic urethane-based, epoxy-based and silicone-based resins.

In the invention, as a polymer for forming the protective film, cellulose acylates (for example, cellulose acetate, cellulose diacetate), polyolefins, cyclic polyolefins (for example, polymers of norbornenes (hereinafter, also referred to as “norbornene-based polymer”), poly(meth)acrylic acid esters (for example, polymethyl methacrylate), polycarbonates and polysulfones are also used. Commercially available polymers (as to norbornene-based polymers, such as ARTON manufactured by JSR, ZEONOR manufactured by ZEON CORPORATION) are preferable. Examples of the above-described norbornene-based polymer include ring-opened polymers of norbornenes (for example, norbornene and a compound formed by condensation of a cycloolefin ring to norbornene are included), a hydrogen adduct thereof, and addition copolymers of norbornenes and ethylene.

The protective film for use in the invention may be film-formed by thermofusion of a thermoplastic polymer resin, or by solution film-forming from a solution uniformly dissolving a polymer (solvent cast method). In the case of the thermofusion film-forming, various additives (for example, a compound for lowering optical anisotropy, a wavelength dispersion controlling agent, an ultraviolet rays protective agent, a plasticizer, a deterioration inhibitor, fine particles, and an optical property-adjusting agent) may be added at the thermofusion. On the other hand, when preparing the protective film from a solution, to the polymer solution (hereinafter, referred to as a “dope”), various additives (for example, a compound for lowering optical anisotropy, a wavelength dispersion controlling agent, an ultraviolet rays protective agent, a plasticizer, a deterioration inhibitor, fine particles, and an optical property-adjusting agent) corresponding to applications may be added in respective preparation processes. As to the timing of the addition, any step in dope formation is allowable, and the step may be the last step of the dope formation.

(Foreside Laminated Body Including the Polarizing Plate)

The foreside laminated body of the liquid crystal display device may include a polarizing plate and, further, optical members to be adhered on the viewer side and the liquid crystal cell side (substrate side) of the polarizing plate.

To the protective film on the liquid crystal cell side of the polarizing plate (substrate side protective film), an optical compensatory film may be used according to need. An optical compensatory film generally refers to an optical material for compensating view angles of a liquid crystal display device in oblique directions, and is the same meaning as a retardation plate and an optical compensatory sheet. The optical compensatory film may be of an integrated type formed by giving an optical compensatory performance to the protective film itself of the polarizing plate, for example, it may be a triacetylcellulose acylate film given an optical compensatory performance to form a protective film of a polarizer. For example, it may be a triacetylcellulose film coated with discotic liquid crystal and then integrated with a polarizing plate.

When an optical compensatory film is arranged to the backside laminated body, for a protective film on the liquid crystal cell side of the polarizing plate of the foreside laminated body (substrate side protective film), a protective film having a small anisotropy of refractive index (not different in the plane direction and thickness direction) may be used.

Whatever the case, the invention is characterized in that the thickness of the protective film on the liquid crystal cell side of the polarizing plate of the foreside laminated body (substrate side protective film) is made thinner than that of the protective film on the viewer side of the polarizing plate of the foreside laminated body (viewer side protective film) by 10 μm or more. The substrate side protective film is made thinner than the viewer side protective film preferably by 20 μm or more, and more preferably by 30 μm or more. The thickness of the substrate side protective film is preferably 50 μm or less, and particularly preferably 30 μm-40 μm. At this time, the thickness of the viewer side protective film is preferably 70 μm or more, and particularly preferably 80 μm-150 μm.

On the viewer side surface of the polarizing plate, a hard coat film, an antireflection film, an antiglare film or the like is arbitrarily arranged by lamination or surface treatment. A hard coat film or hard coat treatment is provided for such purpose as preventing damage of the polarizing plate surface, which can be formed by such technique as adding a hardened membrane excellent in hardness and lubricity, for example, by a suitable ultraviolet-setting type resin such as silicone-based resin on the surface of transparent protective film. An antireflection film or antireflection treatment is provided for the purpose of preventing reflection of outside light from the surface of the polarizing plate, and an antiglare film or antiglare treatment is provided for the purpose of preventing interference of the visibility of transmitted light from the panel due to outside light reflected from the surface of the panel (screen), which may be formed by giving a fine irregular structure to the protective film surface by a suitable technique, for example, a surface roughening technique such as a sandblast technique or emboss technique, or a technique of coating a coating liquid containing transparent fine particles.

(Backside Laminated Body Including a Polarizing Plate)

The backside laminated body of a liquid crystal display device includes a polarizing plate, and further can include an optical member to be adhered on the liquid crystal cell side and the backlight side of the polarizing plate.

According to need, an optical compensatory film may be used on the liquid crystal cell side of the polarizing plate, and a diffusion sheet, brightness enhancing film and the like may be used on the backlight side. Respective members may be adhered with each other by using a sticking agent, wherein the sticking agent is also included in the backside laminated body. In this connection, in the case where a diffusion sheet, a brightness enhancing film or the like is arranged on the backlight side without being adhered directly with the backside polarizing plate, it is not included in the backside laminated body in the invention.

The optical compensatory film of the backside laminated body may be of a type having been integrated with the polarizing plate, similar to one described in the section of the foreside laminated body, or may be formed by laminating plural optical compensatory films. As optical compensatory films for lamination, mainly polymer films are preferably used. For example, a polymer film subjected to biaxial stretching in the plane direction to have birefringence, a two-direction stretched film such as an inclined alignment polymer film which is uniaxially stretched in the plane direction and also in the thickness direction to control the refractive index in the thickness direction, or the like is used. Furthermore, an inclined alignment film is also used. For example, one prepared by adhering a heat-shrinkable film to a polymer film and carrying out a stretching treatment and/or a contracting treatment under the action of the contraction force thereof by heating, one prepared by obliquely aligning liquid crystal polymer, or the like can be mentioned.

Each of members constituting respective layers on the viewer side and the liquid crystal cell side are generally adhered with each other by using a sticking agent. The sticking layer at this time is also included in respective laminated bodies.

The sticking layer can be formed by a suitable sticking agent according to conventional one such as acrylic resin. From the viewpoint of preventing a foaming phenomenon or peeling phenomenon due to moisture absorption, and preventing lowering in optical performance due to difference in thermal expansions, it is preferable that the sticking layer has a low moisture absorptivity and an excellent heat resistance. A sticking layer may be arranged according to need. In the invention, for example, it may be arranged for adhesion between the optical compensatory film and the protective film, between the liquid crystal cell and the protective film, according to need.

(Size of a Panel)

The size of each layer for use in an image display device is equal to that of the panel (screen). Although it depends on the panel size of an image display device, the length of a longer side is preferably 10-500 cm from the viewpoint of a practical size and manufacturing; more preferably 20-500 cm, furthermore preferably 30-500 cm, and particularly preferably 50-500 cm. There is no particular restriction on dimension thereof. However, since warpage of an liquid crystal panel generates easily when it has a wide area, use of the invention in particular for a liquid crystal display device having a large screen is effective.

(Warpage of a Panel)

Warpage of a panel in the invention is measured according to such procedure that a panel is left at rest at a temperature of 50° C. and a relative humidity of 95% for 50 hours, it is moved under a circumstance of a temperature of 25° C. and a relative humidity of 60%, and then measurement is carried out after a time laps of 20 minutes. The warpage is measured for a panel placed on a horizontal platform. Among panel exterior edges lifting from the horizontal platform due to the warpage, the height of the lift at the portion with the largest warpage is measured as a warpage quantity (mm). The warpage quantity w (mm) is divided by the length L (mm) in the longer side direction to give a warpage ratio (w/L). The warpage ratio in the invention satisfies desirably w/L≦0.006, and further desirably w/L≦0.005.

(Image Display Device)

As described above, the image display device of the invention includes various types of image display devices such as a liquid crystal display device, an organic EL display device and a PDP.

A liquid crystal display device as one example of the image display device of the invention can be achieved by using liquid crystal cells with various display modes. As the display mode, various display mode shave been proposed, including IPS (In-Plane Switching), VA (Vertical Aligned), TN (Twisted Nematic), OCB (Optically Compensated Bend), STN (Super Twisted Nematic), ECB (Electrically Controlled Birefringence), FLC (Ferroelectric Liquid Crystal), AFLC (Anti-ferroelectric Liquid Crystal) and HAN (Hybrid Aligned Nematic). Further, display modes obtained from alignment division of the above-described display modes are also proposed.

In order to prevent the warpage of a panel and the corner unevenness of a liquid crystal display device caused by the warpage more effectively, it is desirable to adopt such technique that the absorption axis of a polarizing plate is laminated in parallel with, or perpendicular to the longer side direction of the panel (ordinary lateral direction of the screen). Examples of the display mode generally adopting such lamination include IPS and VA, and liquid crystal cells of these display modes are desirably used in the liquid crystal display device of the invention.

(Cellulose Acylate)

Next, detailed description will be given about cellulose acylate that is preferably used in the invention. In the invention, 2 or more types of cellulose acylates may be used in a mixture.

Next, description will be given about the above-mentioned cellulose acylate of the invention that is manufactured using cellulose as a starting material. The cellulose acylate of the invention is one prepared by acylating a hydroxyl group of cellulose, wherein, as the substituent, any of an acyl group having 2-22 carbon atoms, in which the acyl group having 2 carbon atoms is an acetyl group, may be used. In the cellulose acylate of the invention, there is no particular restriction on the substitution degree of hydrogen atom of hydroxyl group in the glucose units of cellulose. The substitution degree can be obtained from calculation based on measurement of the degree of bond of acetic acid and/or aliphatic acids having 3-22 carbon atoms that substitute hydroxyl groups of cellulose. The measurement can be practiced after ASTM D-817-91.

As the acyl group having 2-22 carbon atoms among acetic acid and/or aliphatic acids having 3-22 carbon atoms that substitute hydroxyl groups of cellulose, either an aliphatic group or anallyl group may be used without particular restriction, and it may be used singly or in a mixture of 2 or more types. Examples of these include alkylcarbonyl esters, alkenylcarbonyl esters, aromatic carbonyl esters and aromatic alkylcarbonyl esters of cellulose, which may have further substituted groups respectively. Examples of the preferable acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octacecanoyl group, an iso-butanoyl group, a t-butanoylgroup, a cyclohexanecarbonyl group, an oleoyl group, a benzoyl group, a naphthylcarbonyl group and a cinnamoyl group. Among these, an acetyl group, a propionyl group, a butanoyl group, a dodecanoyl group, an octacecanoyl group, a t-butanoyl group, an oleoyl group, a benzoyl group, a naphthylcarbonyl group, a cinnamoyl group and the like are preferable, and an acetyl group, a propionyl group and butanoyl group are more preferable.

A glucose unit forming a β-1,4 bond constituting cellulose has a free hydroxyl group at the 2-, 3- and 6-positions. Cellulose acylate is a polymer in which some or all of these hydroxyl groups are esterified by an acyl group. The acyl substitution degree (substitution degree for acyl group) means a ratio of esterification at each of the 2-, 3- and 6-positions of cellulose. When hydroxyl groups are esterified by 100% at each of the 2-, 3- and 6-positions, the substitution degrees at the 2-, 3- and 6-positions are 1; and when all the hydroxyl groups at the 2-, 3- and 6-positions are esterified by 100%, the substitution degree becomes 3. In other words, the summation of the substitution degree (which means A+B, and is also referred to as the total substitution degree) becomes 3. Similarly, acetyl substitution degree, propionyl substitution degree and butanoyl substitution degree mean a percentage of acetylation, propionylation and butanoylation of cellulose, respectively.

In the invention, when denoting a substitution degree of hydrogen atom of 2-hydroxyl group in the glucose units of a cellulose acylate by an acyl group as DS2, a substitution degree of hydrogen atom of 3-hydroxyl group by an acyl group as DS3, and a substitution degree of hydrogen atom of 6-hydroxyl group by an acyl group as DS6, it is preferable to satisfy the following formulae (1) and (2):
2.0≦DS2+DS3+DS6≦3.0 Formula (1):
DS6/(DS2+DS3+DS6)≧0.315 Formula (2):

In the above formulae, DS2+DS3+DS6 is preferably 2.20-3.00, particularly preferably 2.40-2.85. On the other hand, DS6/(DS2+DS3+DS6) is preferably 0.316 or more, more preferably 0.317 or more. The upper limit is preferably 0.36, more preferably 0.35.

As the cellulose acylate for use in the invention, a cellulose acylate being a ixed fatty acid ester of cellulose obtained by substituting hydroxyl groups of cellulose by an acetyl group and acyl groups having 3 or more carbon atoms, and whose substitution degree of hydrogen atom of hydroxyl group in the glucose units of cellulose satisfies the following formulae (3) and (4) is also used preferably:
2.0≦A+B≦3.0 Formula (3):
0<B Formula (4):
wherein A and B represents the substitution degree for acyl groups that have substituted hydroxyl groups of cellulose; A is the substitution degree for an acetyl group and B is the substitution degree for an acyl group having 3 or more carbon atoms.

In the invention, the summation (A+B) of the substitution degrees A and B is, as shown in the above formula (3), preferably 2.00-3.00, more preferably 2.20-3.00, and particularly preferably2.40-2.85. Inaddition, as shownin the above formula (4), the substitution degree B is a value of preferably above 0, more preferably 0.5-2.5, more preferably 0.6-2.0, and particularly preferably 0.7-1.8.

A+B not less than 2.0 results in a weak hydrophilicity, thus the compound tends to be hardly influenced by environmental moisture.

When B is 0, that is, the compound is cellulose acetate, it becomes susceptive to environmental moisture comparatively easily.

Further, as to B, the substitution degree of hydrogen atom of 6-hydroxyl group is preferably 28% or more, more preferably 30% or more, further preferably 31% or more, and particularly preferably 32% or more.

Furthermore, the summation of the substitution degrees of A+B of hydrogen atom of 6-hydroxyl group in cellulose acylate is preferably 0.75 or more, more preferably 0.80 or more, and particularly preferably 0.85 or more. By these cellulose acylates, a solution for film preparation having preferable solubility and filterability can be produced, and preparation of a good solution using a chlorine-free organic solvent also becomes possible. In addition, preparation of a solution having a low viscosity and good filterability becomes possible.

The above-described acyl group having 3 or more carbon atoms may be an aliphatic group or an aromatic hydrocarbon group, and is not particularly restricted. These are, for example, alkylcarbonyl esters, alkenylcarbonyl esters, aromatic carbonyl esters, or aromatic alkylcarbonyl esters of cellulose, which may further include a substituent. Examples of the preferable B include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexane carbonyl group, an oleoyl group, abenzoyl group, anaphthylcarbonyl group and a cinnamoyl group. Among these, preferable ones are a propionyl group, a butanoyl group, a dodecanoyl group, an octadecanoyl group, a t-butanoyl group, an oleoyl group, a benzoyl group, a naphthylcarbonyl group, a cinnamoyl group and the like. Particularly preferable ones are a propionyl group and a butanoyl group. In the case of a propionyl group, the substitution degree B (propionyl substitution degree)is preferably 1.3 or more.

Preferable specific examples of the cellulose acylate include cellulose acetate propionate and cellulose acetate butylate.

(Method for Synthesizing Cellulose Acylate)

The fundamental principle of a method for synthesizing cellulose acylate is described in Migita et al., “Mokuzai Kagaku (Wood Chemistry)” PP. 180-190 (KYORITSU SHUPPAN CO., LTD. 1968). The representative synthesis method is a liquid phase acetylation method through carboxylic acid anhydride—acetic acid—a sulfuric acid catalyst.

Specifically, a cellulose raw material such as cotton linter or wood pulp is pre-treated with an appropriate quantity of acetic acid, which is then thrown into a pre-chilled mixed liquid for carboxylation to form esters, thereby synthesizing a complete cellulose acylate (the sum of acyl substitution degrees at the 2-, 3- and 6-positions is approximately 3.00). The above-mentioned mixed liquid for carboxylation typically contains acetic acid as a solvent, carboxylic acid anhydride as an esterification agent and sulfuric acid as a catalyst. The carboxylic acid anhydride is commonly used in a stoichiometrically excess quantity compared with the sum of the quantity of cellulose to be reacted with the anhydride and moisture existing in the system. After the end of the esterification reaction, an aqueous solution of a neutralizing agent (for example, carbonate, acetate or oxide of calcium, magnesium, iron, aluminumor zinc) is added in order to hydrolysis of excess carboxylic acid anhydride and neutralization of a part of the esterification catalyst remaining in the system. Next, the obtained complete cellulose acylate is saponified and ripened by maintaining it at 50-90° C. in the presence of a small quantity of acetylation reaction catalyst (in general, remaining sulfuric acid) to alter it to a cellulose acylate having a designed acyl substitution degree and polymerization degree. At the time point when a designed cellulose acylate has been obtained, the catalyst remaining in the system is completely neutralized using such neutralizing agent as described above, or, without the neutralization, the cellulose acylate solution is thrown into water or diluted sulfuric acid (or water or diluted sulfuric acid is thrown into the cellulose acylate solution) to separate cellulose acylate, which is subjected to washing, a stabilizing treatment or the like, whereby the above-described specific cellulose acylate can be obtained.

In the cellulose acylate film, a primary polymer component constituting the film preferably consists of the above-described specific cellulose acylate. In the present application, “primary” means 55% by mass or more (preferably 70% by mass or more, more preferably 80% by mass or more) of the polymer component. When manufacturing the polarizing plate of the invention, use of cellulose acylate including a mixed fatty acid ester of cellulose in which some or all hydroxyl groups of cellulose have been substituted by an acetyl group and at least one kind of acyl groups having 3 or more carbon atoms as the primary polymer component can be mentioned as one preferable embodiment.

The cellulose acylate is preferably used in a particulate shape. 90% by mass or more of particles to be used preferably have a particle diameter of 0.5-5 mm. Further, 50% by mass or more of particles to be used preferably have a particle diameter of 1-4 mm. The cellulose acylate particle preferably has a shape close to a sphere as far as possible.

The polymerization degree of cellulose acylate preferably used in the invention is, in viscosity-average polymerization degree, preferably 200-700, more preferably 250-550, further preferably 250-400, and particularly preferably 250-350. The average polymerization degree can be measured according to a limiting viscosity method by Uda et al. (Uda Kazuo, Saito Hideo, Sen-i Gakkai Shi (JOURNAL OF THE SOCIETY OF FIBER SCIENCE AND TECHNOLOGY) vol. 18, No. 1 pp 105-120, 1962). Further, it is described in detail in JP-A-9-95538.

When lower molecular weight components are removed, the average molecular weight (polymerization degree) becomes higher, but the viscosity becomes lower than usual cellulose acylate. Therefore, as the above-mentioned cellulose acylate, one from which lower molecular weight components have been removed is useful. A cellulose acylate containing a small quantity of lower molecular weight components can be obtained by removing lower molecular weight components from cellulose acylate synthesized by a usual method. Lower molecular weight components can be removed by washing cellulose acylate with a suitable organic solvent. Incidentally, when producing a cellulose acylate containing a small quantity of lower molecular weight components, the quantity of the sulfuric acid catalyst in acetylation reaction is preferably adjusted to be 0.5-25 parts by mass relative to 100 parts by mass of cellulose acylate. Adjustment of the sulfuric acid catalyst quantity within the above-described range makes it possible to synthesize cellulose acylate that is also preferable with respect to molecular weight distribution (having uniform molecular weight distribution). When being used in manufacture of cellulose acylate, moisture content thereof is preferably 2% by mass or less, more preferably 1% by mass or less, and in particular 0.7% by mass or less. In general, cellulose acylate contains moisture, whose moisture content is generally 2.5-5% by mass. In order to lower the moisture content within the above range, drying is preferable, wherein a drying method is not particularly restricted when it can give a targeted moisture content.

As to raw cotton and a synthesis method of cellulose acylate, the raw cotton and the synthesis method described in detail in pp 7-12 of KOKAI-GIHO (Disclosure of Techniques) (Kogi No. 2001-1745, published on Mar. 15, 2001 by Japan Institute of Invention and Innovation) can be adopted.

The cellulose acylate film of the invention can be obtained by film-forming using a solution prepared by dissolving the above-mentioned specific cellulose acylate and, according to need, additives.

[Additives]

Examples of the additive that can be used for the above-described cellulose acylate solution include a plasticizer, a UV absorbent, a degradation inhibitor, a retarder (optical anisotropy-developing agent), fine particles, a stripping accelerator and an infrared absorber. In the invention, use of a retarder is preferred. Further, use of one or more types of a plasticizer, a UV absorbent and a stripping accelerator is preferred.

They may be a solid material or an oily material. That is, they are not particularly restricted in the melting point or boiling point thereof. For example, use of a mixture of UV absorbents having a melting point of 20° C. or less and a melting point of 20° C. or more, or, in the same way, use of a mixture of plasticizers is possible. For example, JP-A-2001-151901 describes such use.

As to a UV absorbent, any type can be selected according to the purpose, including salicylic acid ester-based, benzophenone-based, benzotriazole-based, benzoate-based, cyanoacrylate-baded and nickel complex-based absorbers. Preferable examples are benzophenone-based, benzotriazole-based and salicylic acid ester-based absorbers. Examples of the benzophenone-based UV absorbent include 2,4-dihydroxybenzophenone, 2-hydroxy-4-acetoxybenzophenone, 2-hydroxy-4-methoxybenzophenone, 2,2′-di-hydroxy-4-methoxy-benzophenone, 2,2′-di-hydroxy-4,4′-methoxybenzophenone, 2-hydroxy-4-n-octoxybenzophenone, 2-hydroxy-4-dodecyloxy-benzophenone and 2-hydroxy-4-(2-hydroxy-3-methacryloxy)-propoxybenzophenone. Examples of the benzotriazole-based UV absorbent include 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-tert-amylphenyl)benzotriazole, 2-(2′-hydroxy-3′,5′-di-tert-butylphenyl)-5-chlorobenzotriazole, and 2-(2′-hydroxy-5′-tert-octylphenyl)benzotriazole. Examples of the salicylic acid ester-based UV absorbent include phenyl salicylate, p-octylphenyl salicylate and p-tert-butylphenyl salicylate. Among these exemplified UV absorbents, 2-hydroxy-4-methoxybenzophenone, 2,2′-di-hydroxy-4,4′-methoxybenzophenone, 2-(2′-hydroxy-3′-tert-butyl-5′-methylphenyl)-5-chlorobenzotriazole, 2-(2′-hydroxy-5′-tert-butylphenyl)-benzotriazole, 2-(2′-hydroxy-3′,5′-di-tert-amylphenyl)-benzotriazole and 2-(2′-hydroxy-3′,5′-di-tert-butylphenyl)-5-chlorobenzotriazole are particularly preferable.

As to the UV absorbent, combined use of plural absorbers having different absorption wave lengths is preferred because a high blocking effect can be obtained over a wide range of wavelengths. An preferable UV absorbent for use in a liquid crystal is one that is excellent in absorption performance of ultraviolet of 370 nm or less in wavelength from the viewpoint of inhibiting degradation of the liquid crystal, and has little absorption of visible light of 400 nm or more in wavelength from the viewpoint of liquid crystal display device property. Particularly preferable UV absorbents are above-mentioned benzotriazole-based compounds, benzophenone-based compounds and salicylic acid ester-based compounds. Among these, benzotriazole-based compounds are preferable because they give little unnecessary coloring to cellulose ester.

In addition, such compounds as described in respective gazettes of JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509 and JP-A-2000-204173 can be also used as the UV absorbent.

Addition quantity of the UV absorbent is, from the viewpoint of the addition effect and suppression of bleed out of the UV absorbent to film surface, preferably 0.001-5% bymass, more preferably 0.01-1% by mass relative to the cellulose acylate.

The UV absorbent may be added simultaneously at dissolving cellulose acylate, or added to a dope after the dissolution. Particularly, such embodiment that a UV absorbent solution is added to a dope just before casting by using a static mixer or the like is preferred because it allows spectral absorption property to be adjusted easily.

The above-mentioned degradation inhibitor inhibits degradation and decomposition of cellulose triacetate and the like. Examples of the degradation inhibitor include such compounds as butylamine, hindered amine compounds (JP-A-8-325537), guanidine compounds (JP-A-5-271471), benzotriazole-based UV absorbents (JP-A-6-235819) and benzophenone-basedd UV absorbents (JP-A-6-118233).

As the plasticizer, phosphoric acid esters and carboxylic acid esters are preferable. Specific preferable examples of the plasticizer include triphenyl phosphate (TPP), tricresyl phosphate (TCP), cresyldiphenyl phosphate, octyldiphenyl phosphate, diphenylbiphenyl phosphate, trioctyl phosphate, tributyl phosphate, dimethylphthalate (DMP), diethylphthalate (DEP), dibutyl phthalate (DBP), dioctyl phthalate (DOP), diphenyl phthalate (DPP), diethylhexyl phthalate (DEHP), o-acetyltriethyl citrate (OACTE), o-acetyltributyl citrate (OACTB), acetyltriethyl citrate, acetyltributyl citrate, butyl oleate, methylacetyl ricinoleate, dibutyl sebacate, triacetin, tributyrin, butylphthalylbutyl glycolate, etylphthalylethyl glycolate, metylphthalylethyl glycolate and butylphthalylbutyl glycolate. In addition, preferable examples of the plasticizer include (di)pentaerythritol esters, glycerol esters and diglycerol esters.

Examples of the above-mentioned stripping accelerator include ethylesters of citric acid. As to the infrared absorber, compounds described, for example, in JP-A-2001-194522 can be mentioned.

The addition timing of these additives may be at any step of dope-manufacturing process, or they may be added by arranging an additional step for adding the additive as the final preparing step of the dope-preparing process. An addition quantity of respective elements is not particularly restricted as long as function is developed. When the cellulose acylate film has plural layers, types or addition quantities of the additives in each layer may be different from one another. These techniques are described, for example, in JP-A-2001-151902 and the like, which are techniques that have been known conventionally.

For the elasticity of the cellulose acylate film of the invention, the elasticity E(MD) in the casting (conveying) direction and the elasticity E(TD) in the casting width direction (casting transverse direction) preferably satisfy the following formulae (5) and (6), and further the elasticities E(MD) and E(TD) preferably satisfy the following formula (7):
1500 MPa≦E(MD)≦3400 MPa Formula (5):
1200 MPa≦E(TD)≦3400 MPa Formula (6):
0.5≦E(MD)/E(TD)≦2 Formula (7):
wherein the elasticity can be measured with a tensile tester (STROGRAPH-R2, manufactured by TOYO SEIKI KOGYO CO., LTD.).

The elasticity of the cellulose acylate film of the invention can be adjusted so as to satisfy the above-described formulae by selecting the type or addition amount of the above-mentioned plasticizer.

The advantage resulted from making the elasticity E(MD) in the casting (conveying) direction and the elasticity E(TD) in the casting width direction (casting transverse direction) satisfy the above-described formulae (5) and (6) is as follows. When circumstance (humidity) alters, there occurs contraction and expansion in the polarizing plate-constituting portion constituted by the sticking layer, the retardation film, the polarizer, the protective film and the like to generate stress between respective portions. The stress is satisfactorily balanced in the polarizing plate-constituting portion to realize the liquid crystal display device having a polarizing plate with a small alteration of view angle property, thereby giving the preferable result.

The glass transition temperature Tg of the cellulose acylate film of the invention is preferably 70-150° C., and more preferably 80-135° C. The glass transition temperature Tg can be measured with a dynamic viscoelasticity analyzer (Vibron: DVA-225, manufactured by ITK Corp. Ltd). The glass transition temperature also can be adjusted within the above-described range by suitably selecting the type and/or addition amount of the plasticizer. The cellulose acylate film of the invention preferably has the glass transition temperature Tg within the above-described range from the viewpoint of process fitness in polarizing plate processing and liquid crystal display device assembling.

Further, as to the additive, those described in detail in p 16 or later of KOKAI-GIHO (Disclosure of Techniques) (Kogi No. 2001-1745, published on Mar. 15, 2001 by Japan Institute of Invention and Innovation) can be suitably used.

[Retarder]

In order to generate a preferred retardation, a retarder is preferably used in the invention. A retarder composed of a rod-shaped or discotic compound can be used in the invention.

As the rod-shaped or discotic compound, compound having at least two aromatic rings can be used.

The addition amount of a retarder composed of a rod-shaped compound is preferably 0.1-30 parts by mass, more preferably 0.5-20 parts by mass relative to 100 parts by mass of a polymer component containing cellulose acylate.

The addition amount of a retarder composed of a discotic compound is preferably 0.05-20 parts by mass, more preferably 0.1-10 parts by mass, further preferably 0.2-5 parts by mass, most preferably 0.5-2 parts by mass relative to 100 parts by mass of the polymer component containing cellulose acylate.

Discotic compounds are more preferable than rod-shaped compounds in the Rth generation. When generation of a large Rth is needed, discotic compounds are preferably used.

Two or more kinds of retarders may be used simultaneously.

The retarder composed of a rod-shaped or discotic compound preferably has the maximum absorption in the wave length range of 250-400 nm, and preferably has no substantial absorption in the visible light region.

Description will be given about the discotic compound. As the discotic compound, a compound having at least two aromatic rings can be employed.

In the specification, an “aromatic ring” includes an aromatic heteroring, in addition to an aromatic hydrocarbon ring.

The aromatic hydrocarbon ring is particularly preferably a 6-membered ring (that is, benzene ring). Generally, the aromatic heteroring is an unsaturated heteroring. The aromatic heteroring is preferably a 5-membered ring, 6-membered ring or a 7-membered ring, more preferably a 5-membered ring or a 6-membered ring. Generally, the aromatic heteroring has the largest number of double bonds. As hetero atoms, a nitrogen atom, an oxygen atom and a sulfur atom are preferred, and anitrogen atom is particularly preferred. Examples of the aromatic heteroring include a furan ring, a thiophene ring, a pyrrole ring, an oxazole ring, an iso-oxazole ring, a thiazole ring, an iso-thiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring are used preferably, and, in particular, a 1,3,5-triazine ring is preferably used. Specifically, compounds, for example, disclosed in JP-A-2001-166144 are used preferably as a discotic compound.

The number of aromatic rings included in the discotic compound is preferably 2-20, more preferably 2-12, furthermore preferably 2-8, most preferably 2-6.

Relation of two aromatic rings can be classified into following cases (since an aromatic ring, a spiro bond can not be formed): (a) two aromatic rings form a condensed ring, (b) two aromatic rings are directly bonded by a single bond, and (c) two aromatic rings are bonded through a linklng group. Any one of (a)-(c) can be used in the invention.

Examples of the (a) condensed ring (a condensed ring of two or more of aromatic rings) include an indene ring, a naphthalene ring, an azulene ring, a fluorene ring, a phenanthrene ring, an anthracene ring, an acenaphthylene ring, an biphenylene ring, a naphthacene ring, a pyrene ring, an indole ring, an iso-indole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and a thianthrene ring. A naphthalene ring, an azulene ring, an indole ring, a benzoxazole ring, a benzothiazole ring, a benzoimidazole ring, benzotriazole ring and a quinoline ring are preferred.

The single bond in (b) is preferably a carbon-carbon bond bridging two aromatic rings. Two aromatic rings may be bonded by two or more of single bonds to form an aliphatic ring or a non-aromatic heteroring between the two aromatic rings.

The linking group in (c) also bonds, preferably, to carbon atoms of the two aromatic rings. The linking group is preferably an alkylene group, an alkenylene group, an alkynylene group, —CO—, —O—, —NH—, —S— or combinations thereof. Examples of the linking group composed of the combination are shown below. In this connection, the relation of right and left in the following examples of linking group may be reversed.
cl: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfoneamide group, an aliphatic-substituted amino group, an aliphatic-substituted carbamoyl group, an aliphatic-substituted sulfamoyl group, an aliphatic-substituted ureide group and a non-aromatic heterocyclic group.

The number of carbon atoms of the alkyl group is preferably 1-8. A chain alkyl group is preferred to a cyclic alkyl group, and a strait-chain alkyl group is particularly preferred. The alkyl group may further have a substituent (for example, a hydroxyl group, a carboxyl group, an alkoxy group, an alkyl-substituted amino group). Examples of the alkyl group (including the substituted alkyl group) include a methyl group, an ethyl group, a n-butyl group, a n-hexyl group, a 2-hydroxyethyl group, a 4-carboxybutyl group, a 2-methoxyethyl group and 2-diethylaminoethyl group.

The number of carbon atoms of the alkenyl group is preferably 2-8. A chain alkenyl group is preferred to a cyclic alkenylvgroup, and a straight-chain alkenyl group is particularly preferred. The alkenyl group may further have a substituent. Examples of the alkenyl group include a vinyl group, an aryl group and a 1-hexenyl group.

The number of carbon atoms of the alkynyl group is preferably 2-8. A chain alkynyl group is preferred to a cyclic alkynyl group, and a straight-chain alkynyl group is particularly preferred. The alkynyl group may further have a substituent. Examples of the alkynyl group include an ethynyl group, a 1-butynyl group and a 1-hexynyl group.

The number of carbon atoms of the aliphatic acyl group is preferably 1-10. Examples of the aliphatic acyl group include an acetyl group, a propanoyl group and a butanoyl group.

The number of carbon atoms of the aliphatic acyloxy group is preferably 1-10. Example of the aliphatic acyloxy group include an acetoxy group.

The number of carbon atoms of the alkoxy group is preferably 1-8. The alkoxy group may further have an substituent (for example, an alkoxy group). Examples of the alkoxy group (including a substituted alkoxy group) include a methoxy group, an ethoxy group, a butoxy group and a methoxyethoxy group.

The number of carbon atoms of the alkoxycarbonyl group is preferably 2-10. Examples of the alkoxycarbonyl group include a methoxycarbonyl group and an ethoxycarbonyl group.

The number of carbon atoms of the alkoxycarbonylamino group is preferably 2-10. Examples of the alkoxycarbonylamino group include a methoxycarbonylamino group and an ethoxycarbonylamino group.

The number of carbon atoms of the alkylthio group is preferably 1-12. Examples of the alkylthio group include a methylthio group, an ethylthio group and an octylthio group.

The number of carbon atoms of the alkylsulfonyl group is preferably 1-8. Examples of the alkylsulfonyl group include a methanesulfonyl group and an ethanesulfonyl group.

The number of carbon atoms of the aliphatic amide group is preferably 1-10. Example of the aliphatic amide group includes an acetamide group.

The number of carbon atoms of the aliphatic sulfonamido group is preferably 1-8. Examples of the aliphatic sulfonamido group include a methane sulfonamido group, a butane sulfonamido group and a n-octane sulfonamido group.

The number of carbon atoms of the aliphatic-substituted amino group is preferably 1-10. Examples of the aliphatic-substituted amino group include a dimethylamino group, a diethylamino group and a 2-carboxyethylamino group.

The number of carbon atoms of the aliphatic-substituted carbamoyl group is preferably 2-10. Examples of the aliphatic-substituted carbamoyl group include a methylcarbamoyl group and a diethylcarbamoyl group.

The number of carbon atoms of the aliphatic-substituted sulfamoyl group is preferably 1-8. Examples of the aliphatic-substituted sulfamoyl group include a methylsulfamoyl group and a diethylsulfamoyl group.

The number of carbon atoms of the aliphatic-substituted ureide group is preferably 2-10. Example of the aliphatic-substituted ureide group includes a methylureide group.

Examples of the non-aromatic heterocyclic group include a piperidino group and a morphorino group.

Molecular weight of the retarder composed of the discotic compound is preferably 300-800.

Description will be given about the rod-shaped compounds. “The linear molecular structure” means that molecular structure of a rod-shaped compound is linear in the thermodynamically stablest structure. The thermodynamically stablest structure can be obtained by crystal structure analysis or molecular orbital calculation. For example, molecular orbital calculation can be performed using a software for molecular orbital calculation (for example, WinMOPAC2000, manufactured by FUJITSU) to obtain the molecular structure for which heat of formation of the compound becomes least. “The linear molecular structure” means that the angle constituted by the primary chain of the molecular structure is 140 degrees or more in the thermodynamically stablest structure obtained according to the aforementioned calculation.

As the rod-shaped compound, ones having at least two aromatic rings are preferred. As the rod-shaped compound having at least two aromatic rings, compounds represented by formula (1) below are preferred.
Ar¹-L¹-Ar² Formula (1)
wherein Ar¹ and Ar² each independently represents an aromatic group.

In the specification, the aromatic group includes an aryl group (aromatic hydrocarbon group), a substituted aryl group, an aromatic heteroring group and a substituted aromatic heteroring group.

An aryl group and a substituted aryl group are preferred to an aromatic heteroring group and a substituted aromatic heteroring group. A heteroring in the aromatic heteroring group is generally unsaturated. The aromatic heteroring is preferably a 5-membered ring, a 6-membered ring or a 7-membered ring, more preferably a 5-membered ring or a 6-membered ring. The aromatic heteroring generally has the largest number of double bonds. As for the hetero atom, a nitrogen atom, an oxygen atom or a sulfur atom is preferred, and a nitrogen atom or a sulfur atom is more preferred.

Preferable examples of the aromatic ring in the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring. A benzene ring is particularly preferred.

Examples of the substituent of the substituted aryl group and substituted aromatic heteroring group include a halogen atom (F, Cl, Br, I), a hydroxyl group, a carboxyl group, a cyano group, an amino group, an alkylamino group (for example, a methylamino group, an ethylamino group, a butylamino group, a dimethylamino group), a nitro group, a sulfo group, a carbamoyl group, an alkylcarbamoyl group (for example, an N-methylcarbamoyl group, an N-ethylcarbamoyl group, an N,N-dimethylcarbamoyl group), a sulfamoyl group, an alkylsulfamoyl group (for example, an N-methylsulfamoyl group, an N-ethylsulfamoyl group, an N,N-dimethylsulfamoyl group), an ureide group, an alkylureide group (for example, an N-methylureide group, an N,N-dimethylureide group, an N,N,N ′-trimethylureide group), an alkyl group (for example, a methyl group, an ethyl group, a propyl group, a butyl group, a pentyl group, a heptyl group, an octyl group, an isopropyl group, a s-butyl group, a tert-amyl group, a cyclohexyl group, a cyclopentyl group), an alkenyl group (for example, a vinyl group, an aryl group, a hexenyl group), an alkynyl group (for example, an ethynyl group, a butynyl group), an acyl group (for example, a formyl group, an acetyl group, a butyryl group, a hexanoyl group, a lauryl group), an acyloxy group (for example, an acetoxy group, a butylyloxy group, a hexanoyloxy group, a lauryloxy group), an alkoxy group (for example, a methoxy group, an ethoxy group, a propoxy group, a butoxy group, a pentyloxy group, a heptyloxy group, an octyloxy group), an aryloxy group (for example, a phenoxy group), an alkoxycarbonyl group (for example, a methoxycarbonyl group, an ethoxycarbonyl group, a propoxycarbonyl group, a butoxycarbonyl group, a pentyloxycarbonyl group, a heptyloxycarbonyl group), an aryloxycarbonyl group (for example, a phenoxycarbonyl group), an alkoxycarbonylamino group (for example, a butoxycarbonylamino group, a hexyloxycarbonylamino group), an alkylthio group (for example, a methylthio group, an ethylthio group, a propylthio group, a butylthio group, a pentylthio group, a heptylthio group, an octylthio group), an arylthio group (for example, phenylthio group), an alkylsulfonyl group (for example, a methylsulfonyl group, an ethylsulfonyl group, a propylsulfonyl group, a butylsulfonyl group, a pentylsulfonyl group, a heptylsulfonyl group, an octylsulfonyl group), an amide group (for example, an acetamide group, a butylamide group, a hexylamide group, a laurylamide group) and non-aromatic heterocyclic groups (for example, a morphoryl group, a pyrazinyl group).

Preferable examples of the substituent of the substituted aryl group and substituted aromatic heteroring group include a halogen atom, a cyano group, a carboxyl group, a hydroxyl group, an amino group, an alkyl-substituted amino group, an acyl group, an acyloxy group, an amide group, an alkoxycarbonyl group, an alkoxy group, an alkylthio group and an alkyl group.

An alkyl moiety in the alkylamino group, the alkoxycarbonyl group, the alkoxy group and the alkylthio group and the alkyl group may further have a substituent. Examples of the substituent in the alkyl moiety and the alkyl group include a halogen atom, a hydroxyl, carboxyl, cyano, amino and alkylamino groups, a nitro, sulfo, carbamoyl and alkylcarbamoyl groups, a sulfamoyl and alkylsulfamoyl groups, an ureide and alkylureide groups, an alkenyl group, an alkynyl group, an acyl group, an acyloxy group, an acylamino group, an alkoxy group, an aryloxy group, an alkoxycarbonyl group, an ayrloxycarbonyl group, an alkoxycarbonylamino group, an alkylthio group, an arylthio group, an alkylsulfonyl group, an amide group and non-aromatic heterocyclic groups. As the substituent in the alkyl moiety and the alkyl group, a halogen atom, a hydroxyl, an amino and alkylamino groups, an acyl group, an acyloxy group, an acylamino group, an alkoxycarbonyl group and an alkoxy group are preferred.

In the formula (1), L¹ represents a divalent linking group selected from an alkylene group, an alkenylene group, an alkynylene group, —O—, —CO— and groups composed of combinations thereof.

The alkylene group may have a cyclic structure. As a cyclic alkylene group, cicrohexylene is preferred, and 1,4-cyclohexylene is particularly preferred. As a chain alkylene group, a straight-chain alkylene group is preferred to a branched alkylene group.

The number of carbon atoms of an alkylene group is preferablyl-20, more preferably 1-15, further preferably 1-10, furthermore preferably 1-8, most preferably 1-6.

The alkenylene group and the alkynylene group preferably have a chain structure compared with a cyclic structure, more preferably a straight chain structure compared with a branched chain structure.

The number of carbon atoms of the alkenylene group and the alkynylene group is preferably 2-10, more preferably 2-8, further preferably 2-6, furthermore preferably 2-4, most preferably 2 (that is, vinylene or ethynylene). The number of carbon atoms of the arylene group is preferably 6-20, more preferably 6-16, further preferably 6-12.

In the molecular structure of the formula (1), an angle formed by Ar and Ar2across L is preferably 140 degrees or more.

As the rod-shaped compound, compounds represented by the formula (2) below are more preferred.
Ar¹-L²-X-L³⁻Ar² Formula (2)
wherein Ar¹ and Ar² each independently represents an aromatic group. The definition and example for the aromatic group are the same as those for Ar¹ and Ar² of the formula (1).

In the formula (2), L² and L³ each independently represents a divalent linking group selected from an alkylene group, —O—, —CO— and groups composed of combinations thereof.

The alkylene group preferably has a chain structure compared with a cyclic structure, and more preferably has a straight chain structure compared with a branched chain structure.

The number of carbon atoms of the alkylene group is preferably 1-10, more preferably 1-8, further preferably 1-6, furthermore preferably 1-4, most preferably 1 or 2 (that is, methylene or ethylene).

Particularly preferably, L and L³ are —O—CO— or —CO—O—.

In the formula (2), X is 1,4-cyclohexylene, vinylene or ethynylene.

Specific examples of compounds represented by the formula (1) or (2) are shown below. The compounds which can be used in the invention are not limited to these compounds.

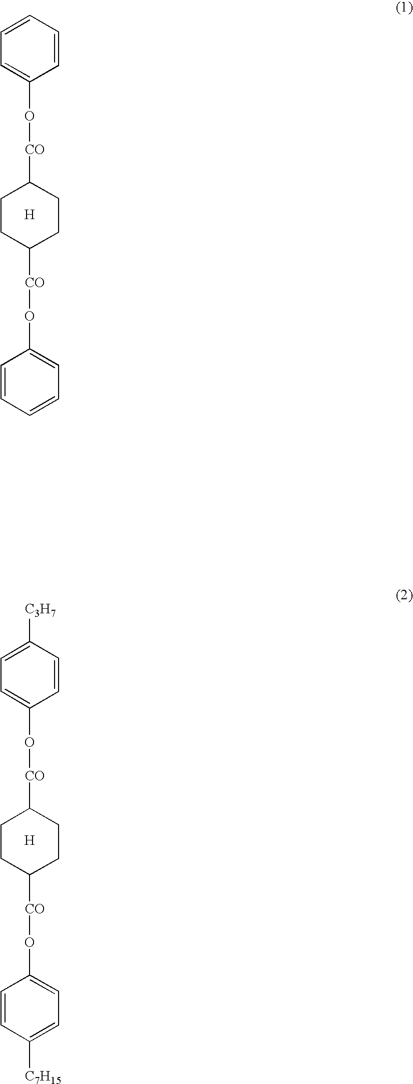

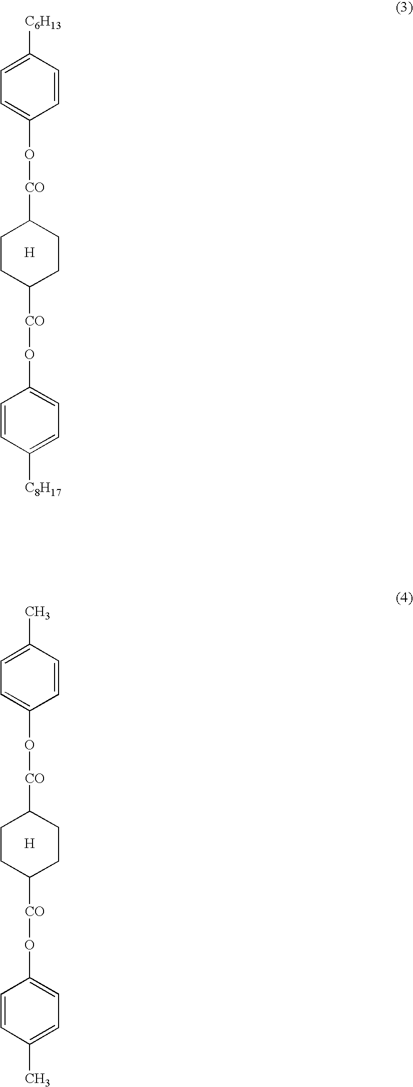

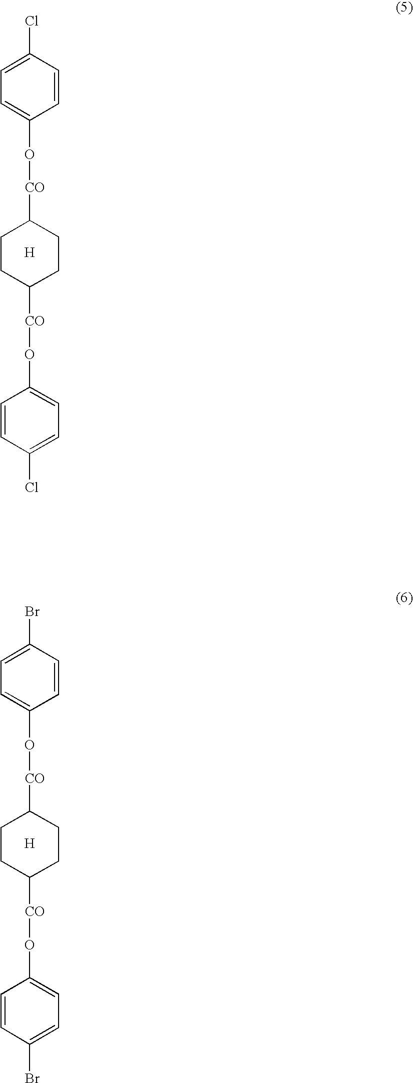

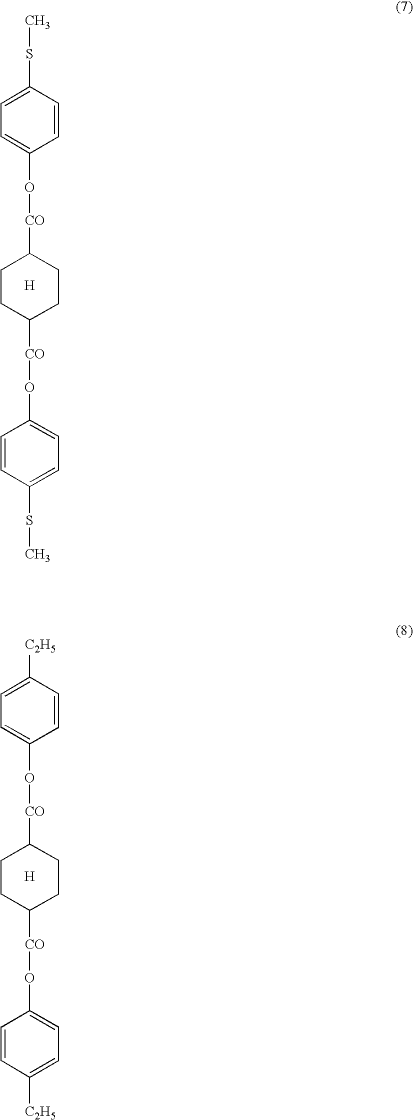

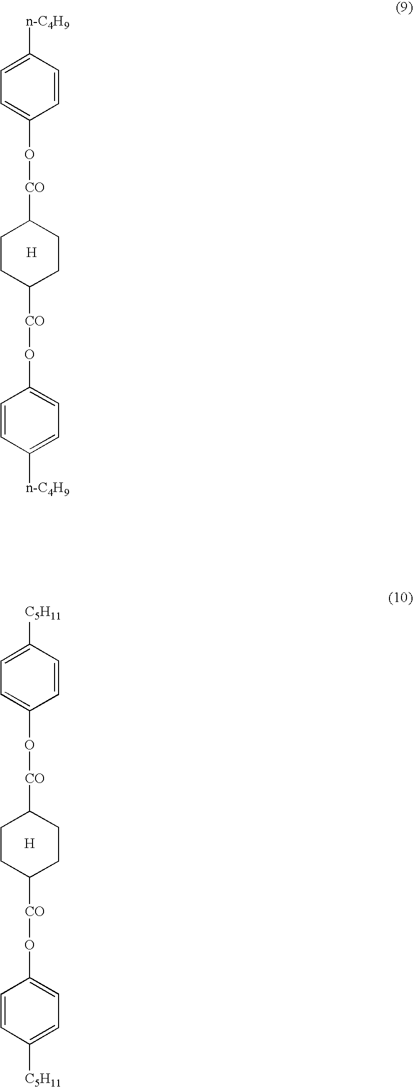

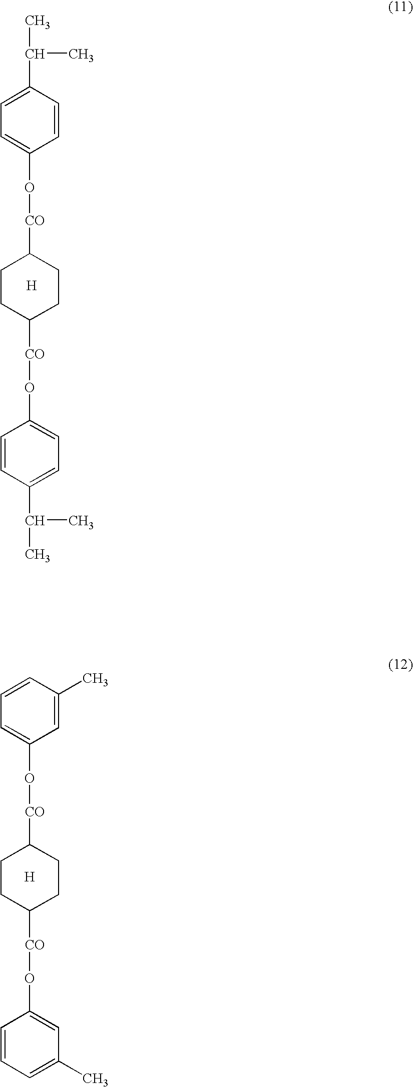

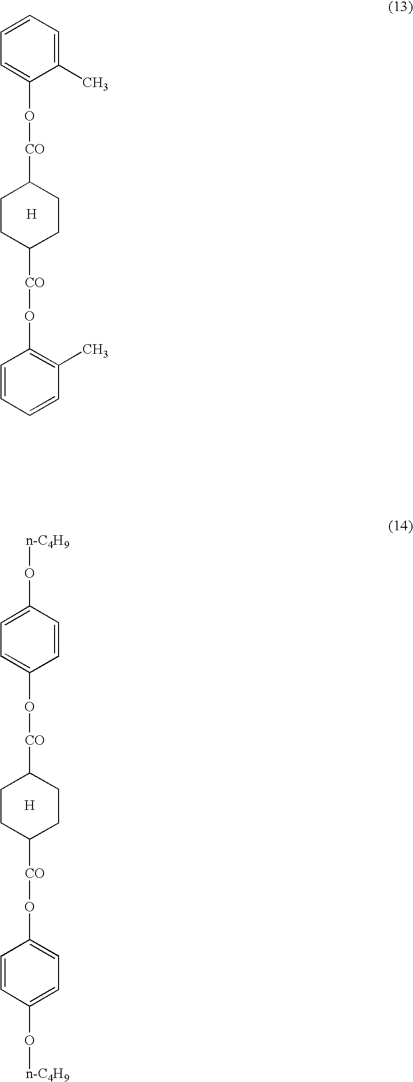

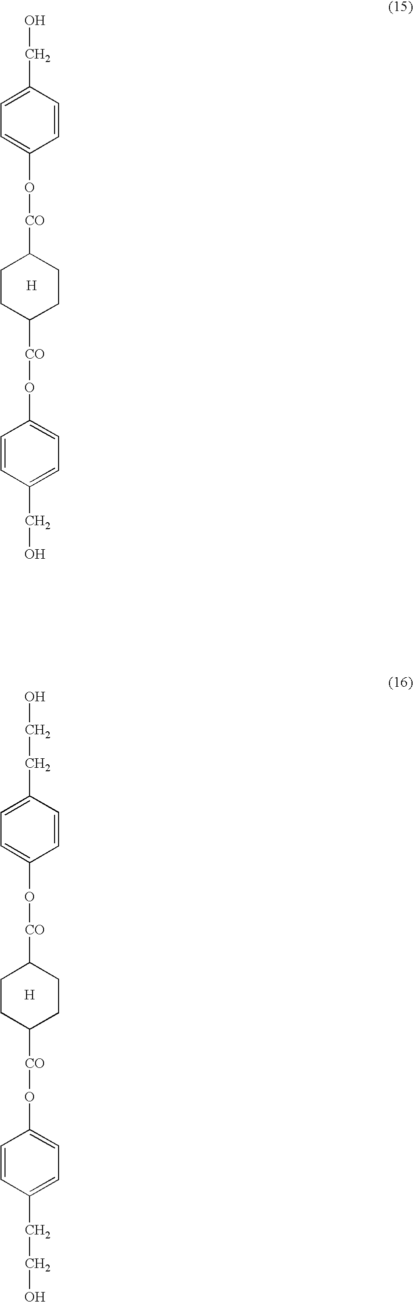

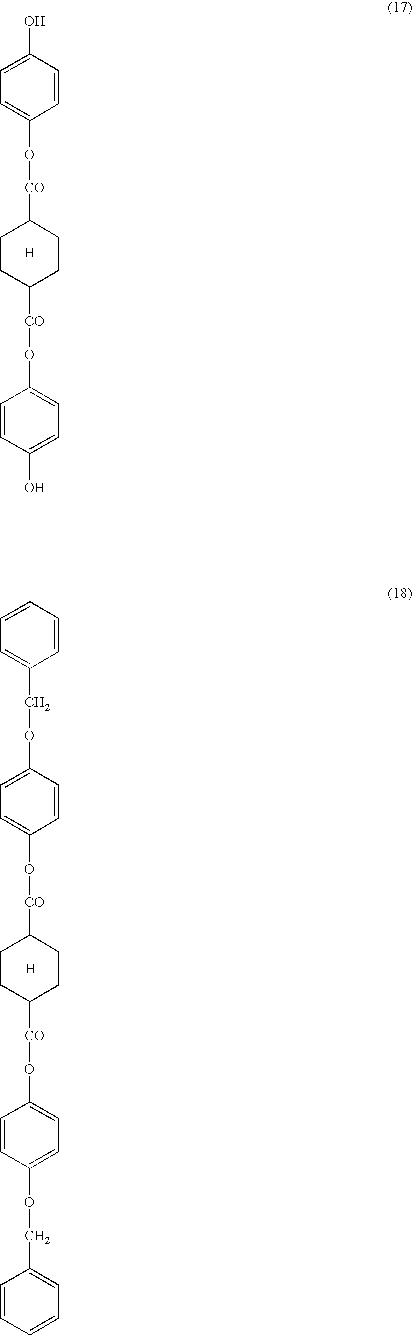

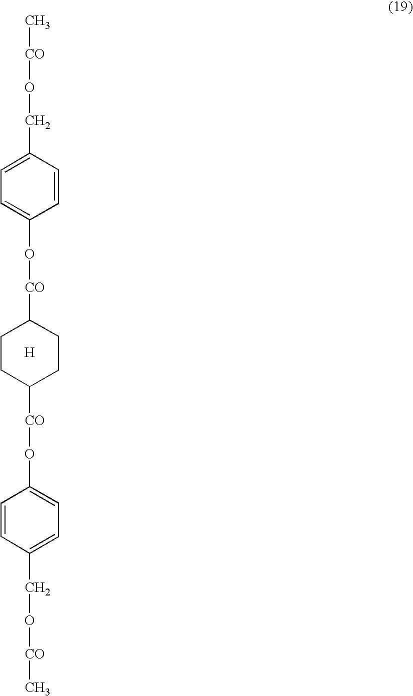

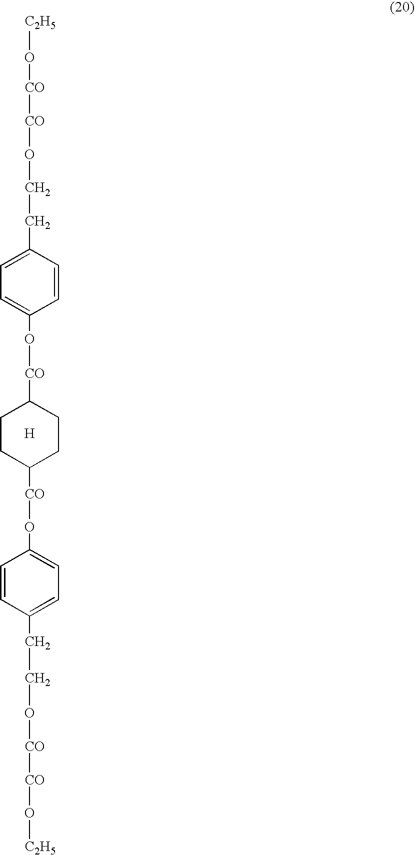

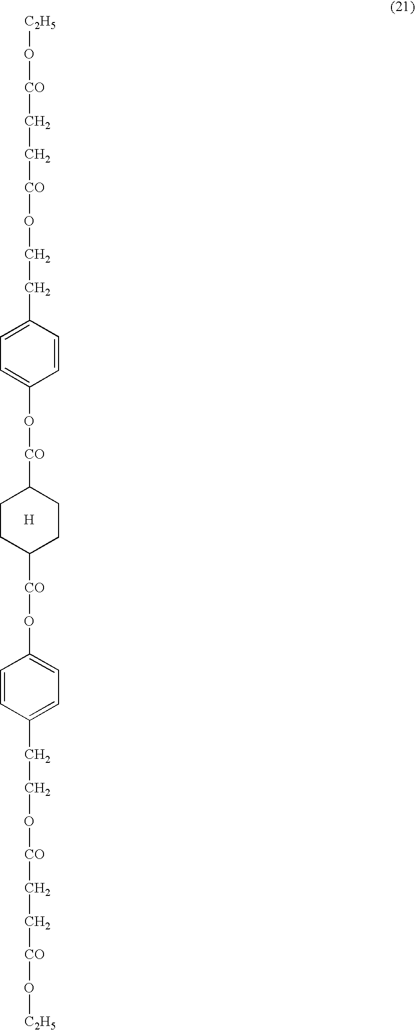

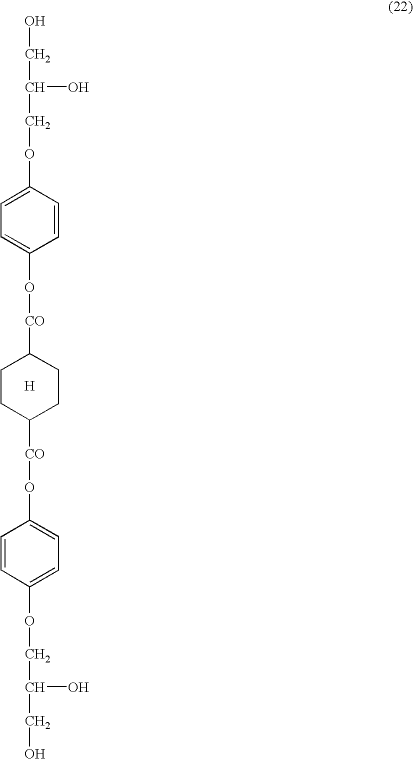

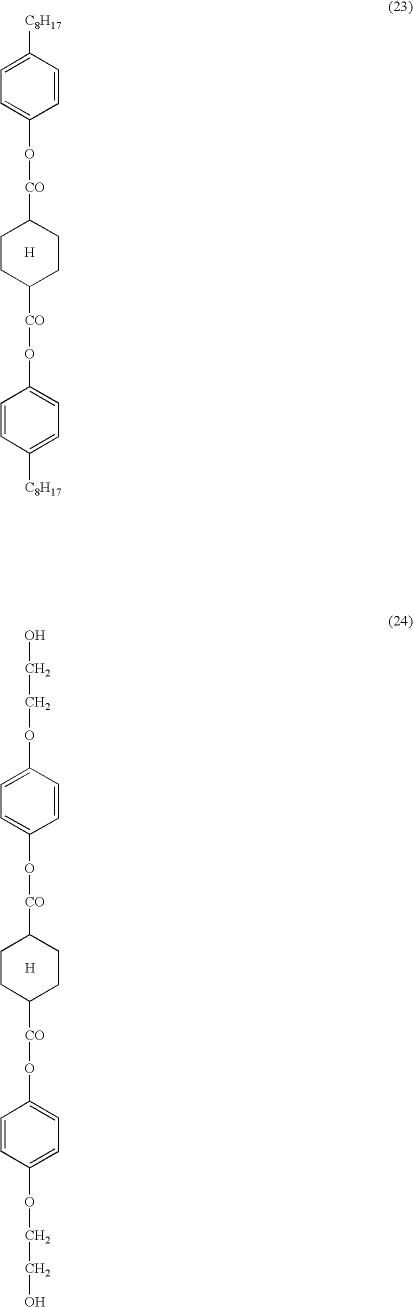

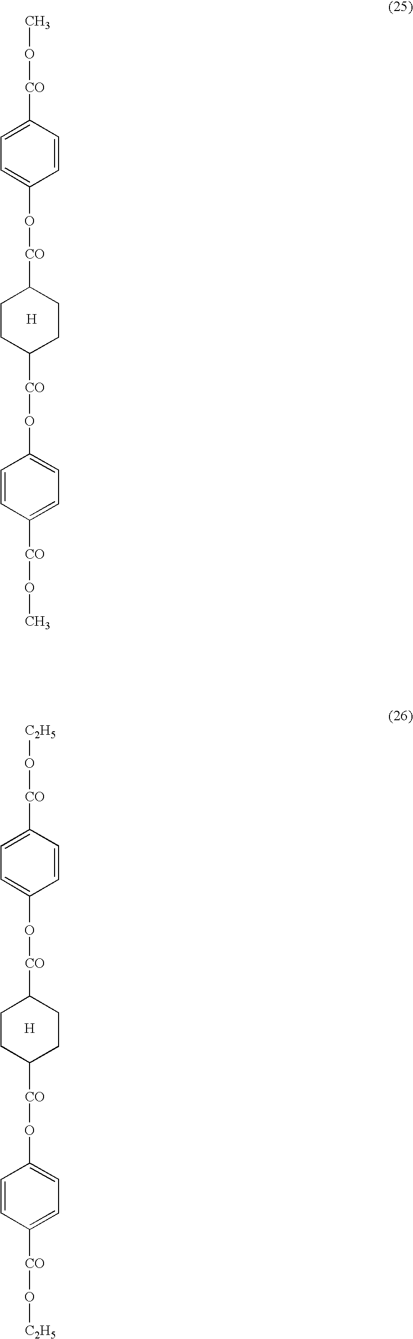

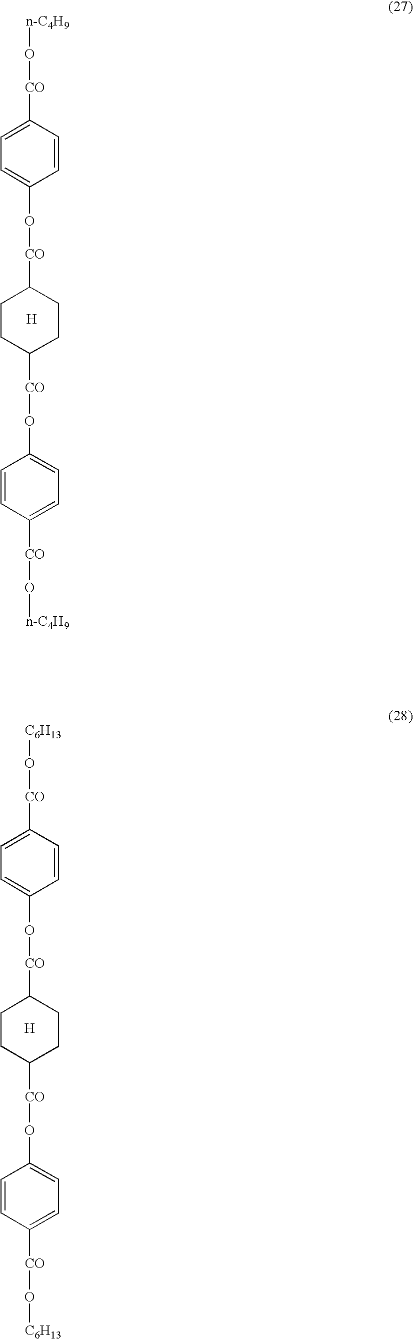

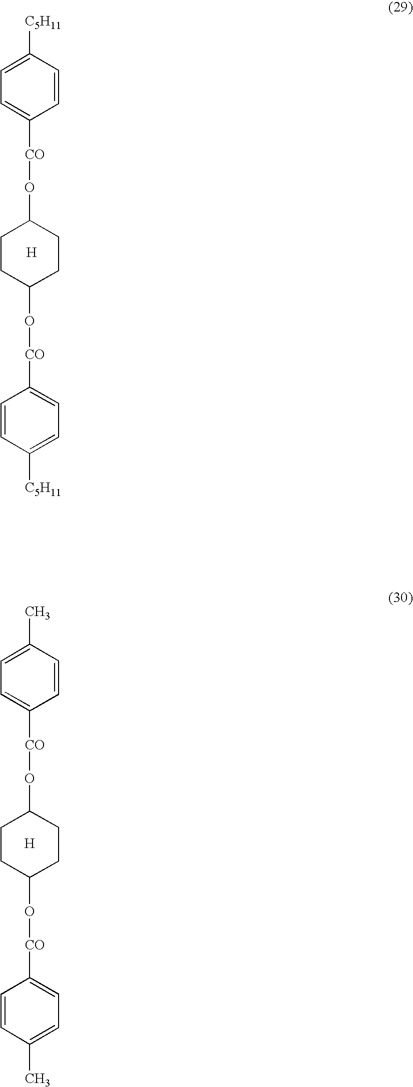

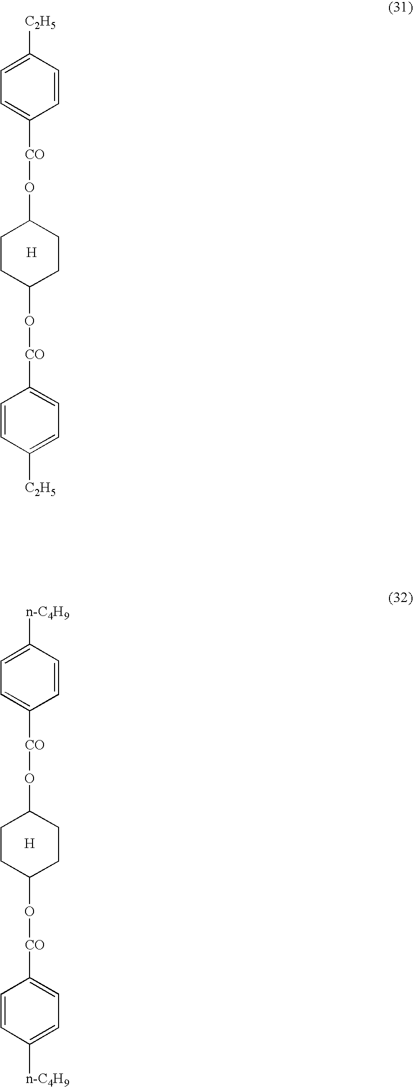

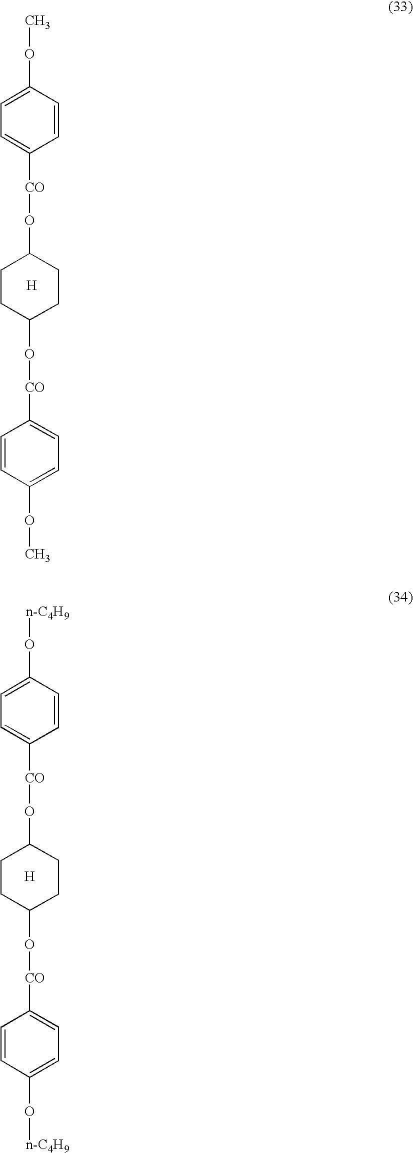

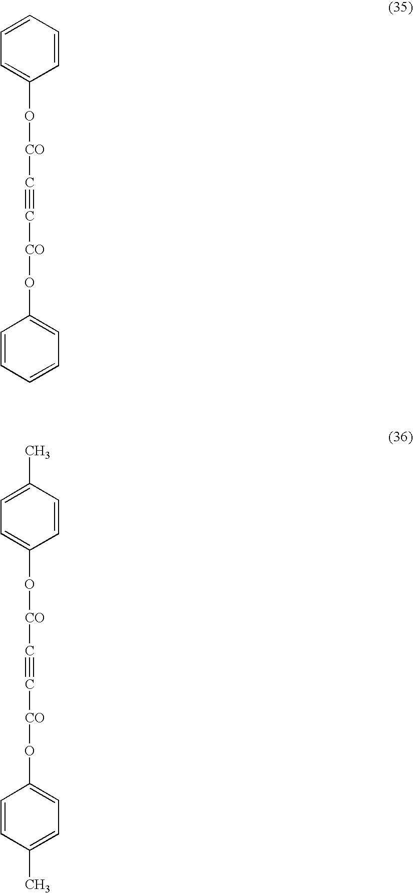

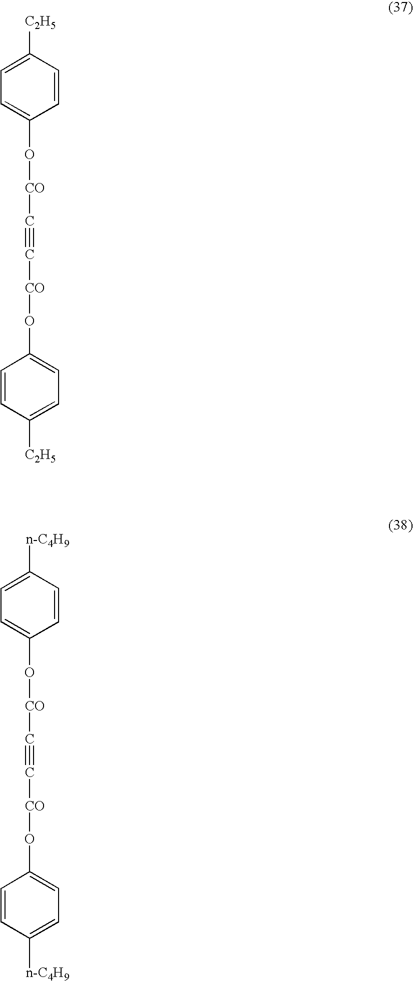

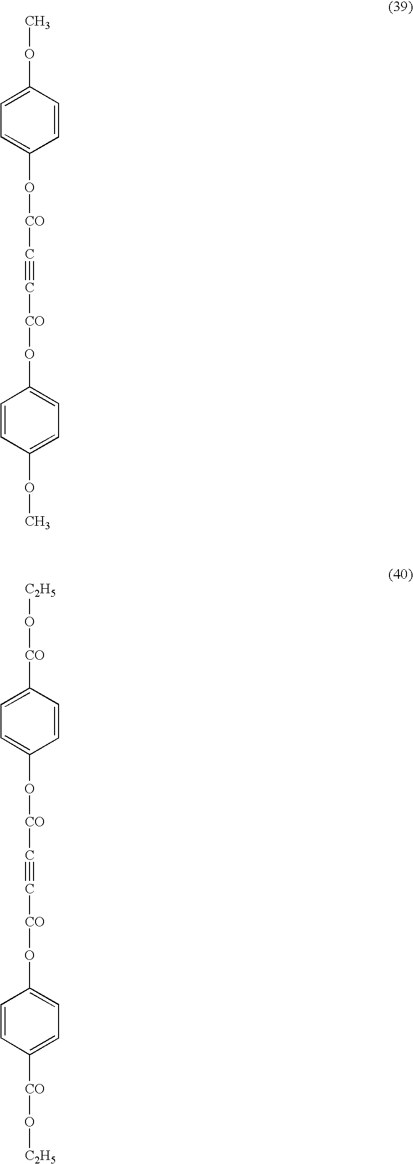

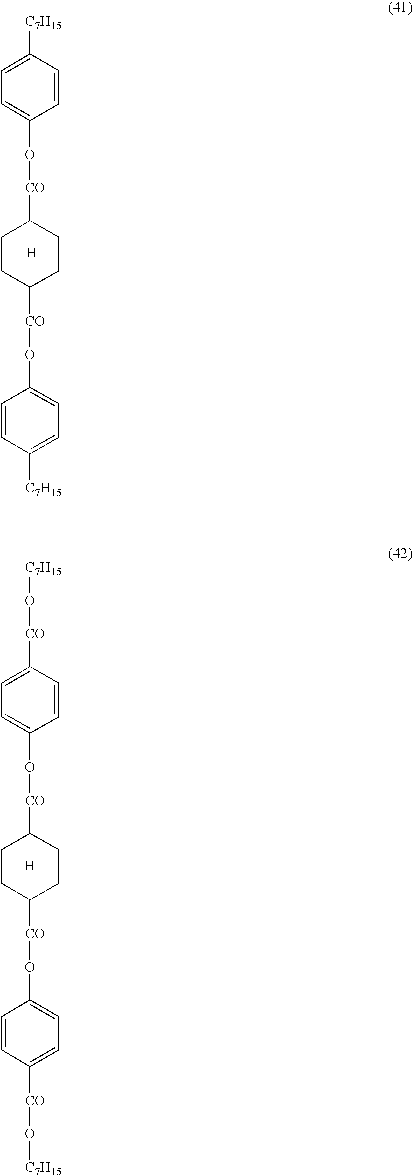

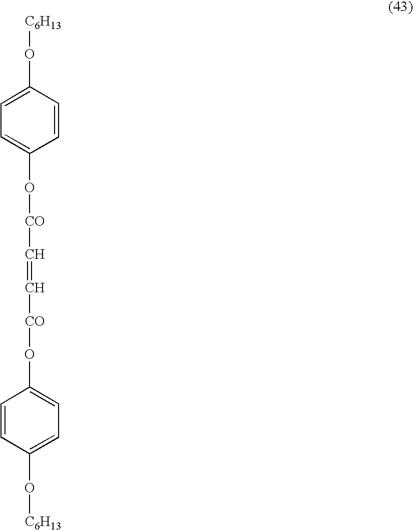

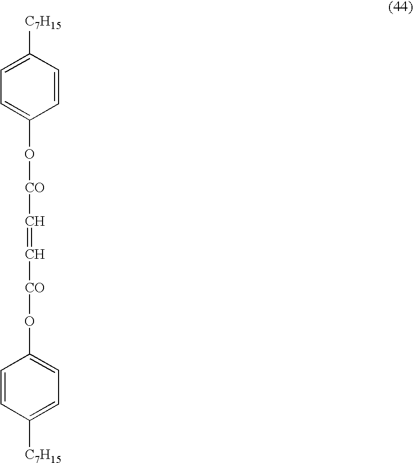

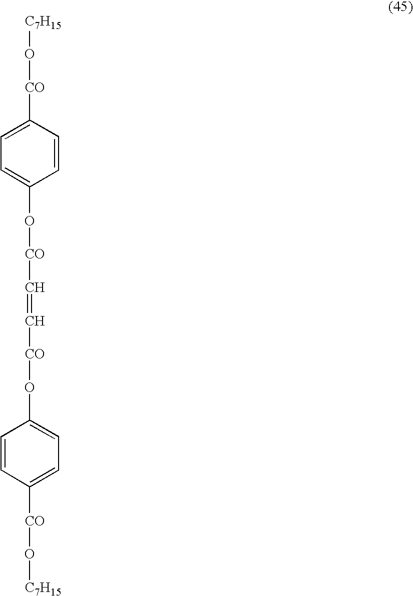

Specificexamples (1)-(34), (41) and (42) have2asymmetric carbon atoms at 1-and 4-sites of the cyclohexane ring. However, since specific examples (1), (4)-(34), (41) and (42) have a symmetric molecular structure of meso form, there are no optical isomers (optical activity), and only geometric isomers (trans form and cis form) exist. The trans form (1-trans) and cis form (1-cis) of the specific example (1) are shown below.

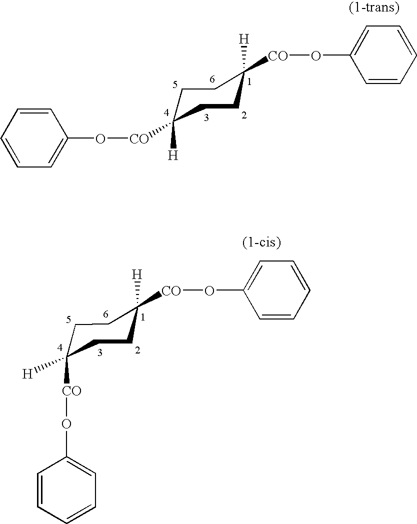

As described above, the rod-shaped compound preferably has a linear molecular structure. Therefore, a trans form is preferred to a cis form.

Specific examples (2) and (3) have optical isomers in addition to geometric isomers (4 kinds of isomers in total). As for the geometric isomers, similarly, the trans form is preferred to the cis form. There are no particular relative merits between the optical isomers, and any of D-, L-and racemic forms may be used.

As for specific examples (43)-(45), there are the trans form and cis form with respect to the vinylene bond at the center. According to the same reason as described above, the trans form is preferred to the cis form.

Other preferred compounds are shown below:

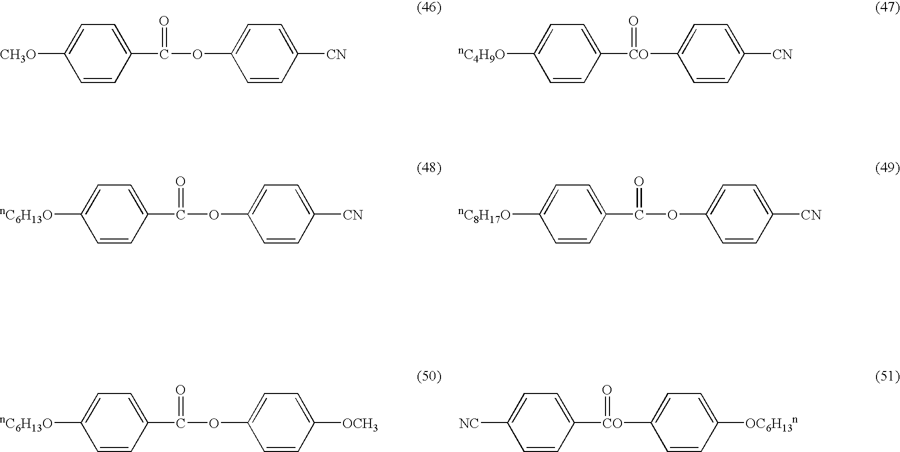

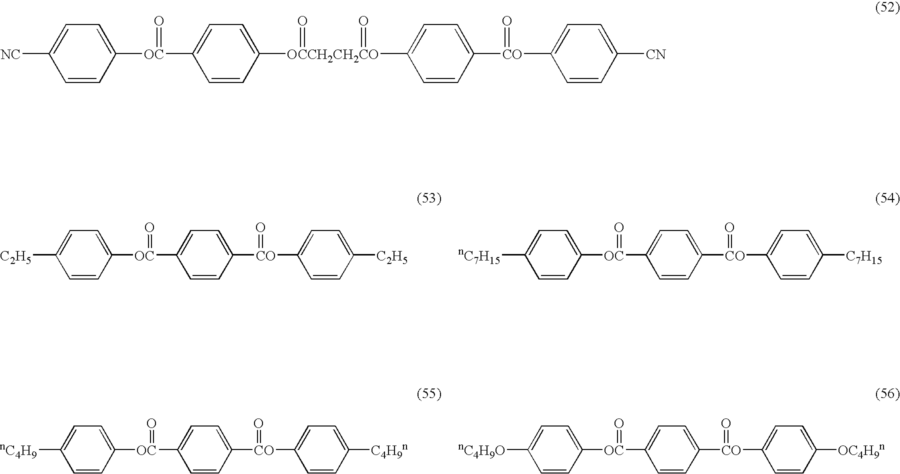

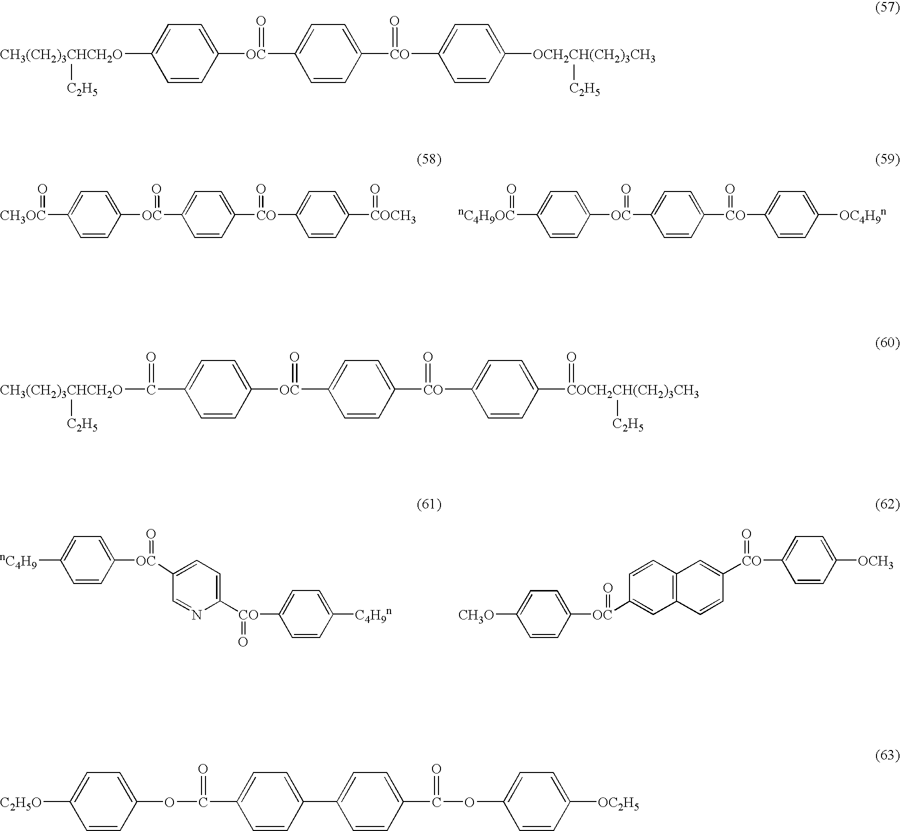

Two kinds or more of the rod-shaped compounds, which have a maximum absorption wavelength (λ max) of less than 250 nm in an ultraviolet spectrum of the solution, may be used simultaneously.

A rod-shaped compound can be synthesized according to methods described in references. As references, Mol. Cryst. Liq. Cryst., vol. 53, p 229 (1979); do. vol. 89, p 93 (1982); do. vol. 145, p 111 (1987); do. vol. 170, p 43 (1989); Journal of the American Chemical Society, vol. 113, p 1349 (1991); do. vol. 118, p 5346 (1996); do. vol. 92, p 1582 (1970); Journal of Organic Chemistry, vol. 40, p 420 (1975); and Tetrahedron, vol. 48, No. 16, p 3437 (1992) can be mentioned.

[Fine particles for matting agent]

Fine particles can be added as a matting agent to the cellulose acylate film of the invention. Examples of the fine particles for use in the invention include silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate and calcium phosphate. Fine particles containing silicon are preferred because turbidity becomes low, and silicon dioxide is particularly preferred. Preferable fine particles of silicon dioxide have a primary average particle size of 20 nm or less, and an apparent specific gravity of 70 g/l or more. Those having the primary average particle size as small as 5-16 nm are more preferred because they can lower haze of the film. As for an apparent specific gravity, 90-200 g/l is preferred, and 100-200 g/l is more preferred. A greater apparent specific gravity makes it possible to manufacture a dispersion liquid having a high concentration to lead to better haze and aggregate, and thus is preferred.

When the silicon dioxide fine particles are used, preferable amount is 0.01-0.3 parts by mass relative to 100 parts by mass of polymer component including the cellulose acylate.

These fine particles forms secondary particles usually having an average particle size of 0.1-3.0 μm and these fine particles exist as aggregates of the primary particles to form irregularity of 0.1-3.0 pin on the surface of the film. As for the secondary average particle size, 0.2 μm-1.5 μm is preferred, 0.4 μm-1.2 μm is more preferred, and 0.6 μm-1.l m is most preferred. The secondary average particle size within the above range exerts sufficient effect of preventing creaking and gives a little haze.

The primary and secondary particle sizes are defined as the diameter of a circle circumscribing the particle, which is obtained by observing particles in the film under a scanning electron microscope. The average particle size is defined as an averaged value of the size of particles obtained by observing 200 particles at different positions.

As fine particles of silicon dioxide, marketed productions can be used, including, for example, AEROSIL R972, R972V, R974, R812, 200, 200V, 300, R202, OX50 and TT600 (all of them are manufactured by NIPPON AEROSIL CO., LTD.) etc. As fine particles of zirconium oxide, for example, those available in the market under trade names of AEROSIL R97 6and R811 (manufactured by NIPPON AEROSIL CO., LTD.) can be used.

Among these, AEROSIL 200V and AEROSIL R972V are particularly preferred, because they are fine particles of silicon dioxide having a primary average particle size of 20 nm or less and an apparent specific gravity of 70 g/l to exert a large effect of lowering a friction coefficient while maintaining turbidity of an optical film at a low level.

In order to obtain a cellulose acylate film having particles with a small secondary average particle size in the invention, several procedures are conceived upon preparing a dispersion liquid of fine particles. For example, there is such method that a dispersion liquid of fine particles is prepared in advance by stirring and mixing a solvent and fine particles, then the dispersion liquid of fine particles is added to a small amount of cellulose acylate solution having been prepared separately to be stirred and dissolved, which is further mixed with a main cellulose acylate dope liquid. This method is a preferable preparation method in that it results in a good dispersibility of silicon dioxide fine particles, hardly allowing the silicon dioxide fine particles to aggregate again. As an alternative, there is also such method that a solvent is added with a small amount of cellulose acylate to be stirred and dissolved, then fine particles are added to the solution to be dispersed by a dispersing apparatus to form a fine particles addition liquid, and the fine particles addition liquid is sufficiently mixed with a dope liquid by an in-line mixer. However, the invention is not restricted to these methods. When silicon dioxide fine particles are dispersed by mixing them with a solvent or the like, concentration of silicon dioxide is preferably 5-30% by mass, more preferably 10-25% by mass, most preferably 15-20% by mass. A higher dispersion concentration results in a lower liquid turbidity relative to the addition amount and better haze and aggregates, and thus is preferred. The final addition amount of a matting agent in a cellulose acylate dope solution is preferably 0.01-1.0 g/m2, more preferably 0.03-0.3 g/m², and most preferably 0.08-0.16 g/m².

As for usable solvents, as lower alcohols, preferable examples include methyl alcohol, ethyl alcohol, propyl alcohol, isopropyl alcohol and butyl alcohol. Solvents other than lower alcohols are not particularly restricted, but use of a solvent that is used at a film-forming step of cellulose acylate is preferred.

Next, organic solvents used for dissolving the cellulose acylate of the invention are described below.

In the invention, as an organic solvent, both of chlorine-containing solvents containing a chlorine-containing organic solvent as a primary solvent and chlorine-free solvents not containing a chlorine containing organic solvent can be used.

[Chlorine-containing solvent]

Upon manufacturing a solution of the cellulose acylate of the invention, a chlorine-containing organic solvent is used preferably as a primary solvent. In the invention, kind of the chlorine-containing organic solvent is not particularly limited as long as the purpose of dissolving, casting and film-forming the cellulose acylate can be achieved. Preferable examples of the chlorine-containing organic solvent are dichloromethane and chloroform. Particularly, dichloromethane is preferred. Further, mixing an organic solvent other than a chlorine-containing organic solvent results in no particular problem. In this case, use of at least 50% by mass of dichloromethane is required relative to the total amount of organic solvents. Hereinafter, description will be given about other organic solvents that may be used simultaneously with a chlorine-containing organic solvent in the invention. Examples of other preferable organic solvents include the solvent selected from esters, ketones, ethers, alcohols and hydrocarbons having 3-12 carbon atoms. These esters, ketones, ethers and alcohols may have a cyclic structure. Compounds having two or more of any functional groups of ester, ketone and ether (that is, —O—, —CO— or —COO—) may also be used as a solvent, that is, they may have other functional group such as, for example, an alcoholic hydroxyl group at the same time. In the case of a solvent having two or more kinds of functional groups, number of carbon atoms thereof is sufficient when it falls in the range defined for a compound having any one kind of functional group. Examples of esters having 3-12 carbon atoms include ethyl formate, propyl formate, pentyl formate, methylacetate, ethylacetate, pentyl acetate and the like. Examples of ketones having 3-12 carbon atoms include acetone, methylethylketone, diethylketone, diisobutylketone, cyclopentanone, cyclohexanone, methylcyclohexanone and the like. Examples of ethers having 3-12 carbon atoms include diisopropylether, dimethoxymethane, dimethoxyethane, 1,4-dioxane, 1,3-dioxolan, tetrahydrofuran, anisole, phenetol and the like. Examples of the organic solvent having two or more kids of functional groups include 2-ethoxyethylacetate, 2-methoxyethanol, 2-buthoxyethanol and the like.

An alcohol that can be used in combination with the chlorine-containing organic solvent may be of straight chain, branched chain or cycle. Among them, an alcohol based on a saturated aliphatic hydrocarbon is preferred. A hydroxyl group of the alcohol may be any of primary to tertiary. Examples of the alcohol include methanol, ethanol, 1-propanol, 2-propanol, 1-butanol, 2-butanol, tert-butanol, 1-pentanol, 2-methyl-2-butanol and cyclohexanol. In addition, as an alcohol, fluorine-containing alcohols may be used. For example, 2-fluoroethanol, 2,2,2-trifluoroethanol, 2,2,3,3-tetrafluoro-1-propanol and the like can be mentioned. Further, the hydrocarbon may be of strait chain, branched chain or cycle. Either an aromatic hydrocarbon or an aliphatic hydrocarbon is usable. The aliphatic hydrocarbon may be saturated or unsaturated. Examples of the hydrocarbon include cyclohexane, hexane, benzene, toluene and xylene.

Examples of combination of a chlorine-containing organic solvent and other organic solvent include combinations of following compositions. However, the composition usable in the invention is not limited to these.
dichloromethane/methanol/ethanol/butanol (80/10/5/5, parts by mass),
dichloromethane/acetone/methanol/propanol (80/10/5/5, parts by mass),
dichloromethane/methanol/butanol/cyclohexane (80/10/5/5, parts by mass),
dichloromethane/methylethylketone/methanol/butanol (80/10/5/5, parts by mass),
dichloromethane/acetone/methylethylketone/ethanol/isopropanol (75/10/10/5/7, parts by mass),
dichloromethane/cyclopentanone/methanol/isopropanol (80/10/5/8, parts by mass),
dichloromethane/methylacetate/butanol (80/10/10, parts by mass),
dichloromethane/cyclohexanone/methanol/hexane (70/20/5/5, parts by mass),
dichloromethane/methylethylketone/acetone/methanol/ethanol (50/20/20/5/5, parts by mass),
dichloromethane/1,3-dioxolan/methanol/ethanol (70/20/5/5, parts by mass),
dichloromethane/dioxane/acetone/methanol/ethanol (60/20/10/5/5, parts by mass),
dichloromethane/acetone/cyclopentanone/ethanol/isobutanol/cyclohexane (65/10/10/5/5/5, parts by mass),
dichloromethane/methylethylketone/acetone/methanol/ethanol (70/10/10/5/5, parts by mass),
dichloromethane/acetone/ethylacetate/ethanol/butanol/hexane (65/10/10/5/5/5, parts by mass),
dichloromethane/acetomethylacetate/methanol/ethanol (65/20/10/5, parts by mass),
dichloromethane/cyclopentanone/ethanol/butanol (65/20/10/5, parts by mass),
   [Chlorine-free solvent]

Next, description will be given about chlorine-free organic solvents that are preferably used on manufacturing a solution of the cellulose acylate of the invention. In the invention, the chlorine-free organic solvent is not particularly limited as long as the purpose of dissolving, casting and film-forming the cellulose acylate can be achieved. As for the chlorine-free organic solvent used in the invention, a solvent selected fromesters, ketones andethers having 3-12 carbon atoms is preferred. These esters, ketones and ethers may have acyclic structure. Compounds having two or more of any functional groups of ester, ketone and ether (that is, —O—, —CO— or —COO—) may also be used as a primary solvent, that is, they may have other functional group such as, for example, an alcoholic hydroxyl group. In the case of a primary solvent having two or more kinds of functional groups, number of carbon atoms thereof is sufficient when it falls in the range defined for a compound having any one kind of functional group. Examples of esters having 3-12 carbon atoms include ethyl formate, propyl formate, pentyl formate, methylacetate, ethylacetate and pentyl acetate. Examples of ketones having 3-12 carbon atoms include acetone, methylethylketone, diethylketone, diisobutylketone, cyclopentanone, cyclohexanone and methylcyclohexanone. Examples of ethers having 3-12 carbon atoms include diisopropylether, dimethoxymethane, dimethoxyethane, 1,4-dioxane, 1,3-dioxolan, tetrahydrofuran, anisole and phenetol. Examples of the organic solvent having two or more kids of functional groups include 2-ethoxyethylacetate, 2-methoxyethanol and 2-buthoxyethanol.

The foregoing chlorine-free organic solvents used for the cellulose acylate are selected on the basis of the above-described various viewpoints, and preferably as follows. That is, as for the chlorine-free organic solvent, a mixed solvent containing the aforementioned chlorine-free organic solvent as a primary solvent is preferred. Among them, a mixed solvent of three or more kinds of solvents differing from one another, wherein a first solvent is at least one kind selected from methylacetate, ethylacetate, methylformate, ethylformate, acetone, dioxolan, dioxane and a mixture thereof, a second solvent is selected from ketones and acetoacetic acid esters having 4-7 carbon atoms, and a third solvent is selected from alcohols and hydrocarbons having 1-10 carbon atoms and, more preferably, from alcohols having 1-8 carbon atoms, is preferred. In this connection, when the first solvent is a mixed liquid of two or more kinds of solvents, no second solvent may be contained. The first solvent is, more preferably, methylacetate, acetone, methylformate, ethylformate, or a mixture thereof. The second solvent is, preferably, methylethylketone, cyclopentanone, cyclohexanone or acetylmethylacetate, or a mixture thereof may be usable.

An alcohol as the third solvent may be of straight chain, branched chain or cycle. Among them, one based on a saturated aliphatic hydrocarbon is preferred. A hydroxyl group of the alcohol may be any of primary to tertiary. Examples of the alcohol include methanol, ethanol, 1-propanol, 2-propanol, 1-butanol, 2-butanol, tert-butanol, 1-pentanol, 2-methyl-2-butanol and cyclohexanol. In addition, as the alcohol, fluorine-containing alcohol maybe usable, including, for example, 2-fluoroethanol, 2,2,2-trifluoroethanol and 2,2,3,3-tetrafluoro-1propanol. Further, hydrocarbon may be of straight chain, branched chain, or cycle. Either an aromatic hydrocarbon or an aliphatic hydrocarbon is usable. The aliphatic hydrocarbon may be saturated or unsaturated. Examples of the hydrocarbon include cyclohexane, hexane, benzene, toluene and xylene. These alcohols and hydrocarbons as the third solvent may be usable separately or as a mixture of two or more kinds thereof, and not particularly restricted. Specific preferable compounds of the third solvents include methanol, ethanol, 1-propanol, 2-propanol, 1-butanol, 2-butanol and cyclohexanol as alcohols, cyclohexane and hexane, and in particular, methanol, ethanol, 1-propanol, 2-propanol and 1-butanol.

On the basis of the total amount of the mixed solvent, the mixing ratio of the foregoing three kinds of solvents is that preferably the first solvent is contained in 20-95% by mass, the second solvent in 2-60% by mass and further the third solvent in 2-30% by mass, more preferably the first solvent is contained in 30-90% by mass, the second solvent in 3-50% by mass, and the third alcohol in 3-25% by mass. Furthermore, particularly preferably the first solvent is contained in 30-90% by mass, the second solvent in 3-30% by mass, and the third solvent is alcohol and contained in3-15% by mass. About the chlorine-free organic solvent used in the invention is described in more detail in pp 12-16 of KOKAI-GIHO (Disclosure of Techniques) (Kogi No. 2001-1745, published on Mar. 15, 2001 by Japan Institute of Invention and Innovation).

Preferable compositions of the chlorine-free organic solvent in the invention are listed below. However, usable compositions in the invention are not restricted to these.
methylacetate/acetone/methanol/ethanol/butanol (75/10/5/5/5, parts by mass),
methylacetate/acetone/methanol/ethanol/propanol (75/10/5/5/5, parts by mass),
methylacetate/acetone/methanol/butanol/cyclohexane (75/10/5/5/5, parts by mass),
methylacetate/acetone/ethanol/butanol (81/8/7/4, parts by mass),
methylacetate/acetone/ethanol/butanol (82/10/4/4, parts by mass),
methylacetate/acetone/ethanol/butanol (80/10/4/6, parts by mass),
methylacetate/methylethylketone/methanol/butanol (80/10/5/5, parts by mass),
methylacetate/acetone/methylethylketone/ethanol/isopropanol (75/10/10/5/7, parts by mass),
methylacetate/cyclopentanone/methanol/isopropanol (80/10/5/8, parts by mass),
methylacetate/acetone/butanol (85/5/5, parts by mass),
methylacetate/cyclopentanone/acetone/methanol/butanol (60/15/15/5/6, parts by mass),
methylacetate/cyclohexanone/methanol/hexane (70/20/5/5, parts by mass),
methylacetate/methylethylketone/acetone/methanol/ethanol (50/20/20/5/5, parts by mass),
methylacetate/1,3-dioxolan/methanol/ethanol (70/20/5/5, parts by mass),
methylacetate/dioxane/acetone/methanol/ethanol (60/20/10/5/5, parts by mass),
methylacetate/acetone/cyclopentanone/ethanol/isobutanol/cyclohexane (65/10/10/5/5/5, parts by mass),
methylformate/methylethylketone/acetone/methanol/ethanol (50/20/20/5/5, parts by mass),
methylformate/acetone/ethylacetate/ethanol/butanol/hexane (65/10/10/5/5/5, parts by mass),
acetone/acetomethylacetate/methanol/ethanol (65/20/10/5, parts by mass),
*acetone/cyclopentanone/ethanol/butanol (65/20/10/5, parts by mass),
acetone/1,3-dioxolan/ethanol/butanol (65/20/10/5, parts by mass),
1,3-dioxolan/cyclohexanone/methylethylketone/methanol/butanol (55/20/10/5/5/5, parts by mass)

Further, cellulose acylate solutions prepared by following methods may also be used:
a method in which a cellulose acylate solution is manufactured using methylacetate/acetone/ethanol/butanol (81/8/7/4, parts by mass) and then filtered and concentrated followed by additional addition of 2 parts by mass of butanol;
a method in which a cellulose acylate solution is manufactured using methylacetate/acetone/ethanol/butanol (84/10/4/2, parts by mass) and then filtered and concentrated followed by additional addition of 4 parts by mass of butanol; and
a method in which a cellulose acylate solution is manufactured using methylacetate/acetone/ethanol (84/10/6, parts by mass) and then filtered and concentrated followed by additional addition of 5 parts by mass of butanol.

In the cellulose acylate solution (dope) for use in the invention, dichloromethane may be incorporated in a amount of 10% by mass or less of the total amount of the organic solvents to the above-described chlorine-free organic solvent of the invention.

[Properties of the Cellulose Acylate Solution]p As for the cellulose acylate solution, a solution manufactured by dissolving cellulose acylate in the aforementioned organic solvent in 10-30% by mass is preferred, in 13-27% by mass is more preferred, and in 15-25% by mass is particularly preferred, from the viewpoint of aptitude for film-forming and casting. In order to adjust the concentration of the cellulose acylate solution, cellulose acylate may be dissolved so that the solution has a designed concentration, or dissolved in a lower concentration (for example, 9-14% by mass) in advance and then concentrated in a concentration step described later to form a solution having a designed higher concentration. Or, in advance, a cellulose acylate solution having a higher concentration is prepared, to which various additives are added to give a cellulose acylate solution having a designed lower concentration. Either method has no particular problem only when it can give the cellulose acylate solution having the concentration of the invention.

In the invention, a molecular weight of cellulose acylate association body in a diluted solution, which has been prepared by diluting an cellulose acylate solution with an organic solvent having the same composition to become of 0.1-5% by mass, is preferably 150,000-15,000,000, more preferably 180,000-9,000,000.

The association molecular weight can be obtained by a static light scattering method. On this occasion, it is preferred to dissolve cellulose acylate so that an inertial square radius obtained at the same time will become 10-200 nm. The more preferred inertial square radius is 20-200 nm. Furthermore, it is preferred to dissolve cellulose acylate so that the second virial coefficient will become −2×10⁻⁴- +4×10⁻⁴, and more preferred to dissolve it so that the second virial coefficient will become −2×10⁻⁴- +2×10⁻⁴.

Here, respective definitions of the association molecular weight, the inertial square radius and the second virial coefficient in the invention will be described. These are measured according to a method described below using a static light scattering method. As a matter of convenience of an apparatus, the measurement is performed using a sample in a diluted region, but these measured values reflect behavior of the dope of the invention in a high concentration region.

First, cellulose acylate is dissolved in a solvent used for a dope to prepare solutions of 0.1% by mass, 0.2% by mass, 0.3% by mass and 0.4% by mass, respectively. Here, cellulose acylate to be used is dried in advance at 120° C. for 2 hours, which is weighed at 25° C. and relative humidity of 10% in order to prevent moisture absorbent. The dissolution is performed according to the method employed at dissolving the dope (ordinary temperature dissolving method, cooling dissolving method, high-temperature dissolving method). Subsequently, these solutions and solvents are filtered on a 0.2 μm Teflon filter (Teflon: registered trade mark). Then the filtered solution is subjected to measurement of static light scattering using a light scattering measurement apparatus (DLS-700, manufactured by OTSUKA ELECTRONICS CO., LTD.) at 25° C. from 30° to 140° at 10° intervals. The resultant data are analyzed by the BERRY plot method. In this connection, as for values necessary for the analysis, a refraction index used was a value of the solvent obtained using the Abbe refraction system, and concentration gradient (dn/dc) of the refraction index was measured using a differential refractometer (DRM-1021, manufactured by OTSUKA ELECTRONICS CO., LTD.) while using the solvent and the solution used for measuring light scattering.

[Preparation of Dope]

Next, preparation of a cellulose acylate solution (dope) will be described. A method for dissolving cellulose acylate is not particularly restricted and can be practiced at room temperature, by a cooling dissolving method or a high-temperature dissolving method, or further by a combined method of these. Preparation methods of a cellulose acylate solution are described in, forexample, JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017, JP-A-11-302388 etc.

These methods of dissolving cellulose acylate in an organic solvent described above are technologies also suitably applicable for the invention within the range of the invention. Details of these, particularly a chlorine-free solvent system containing an organic solvent, are practiced according to the method described in detail inpp 22-25 of KOKAI-GIHO (Disclosure of Techniques) (Kogi No. 2001-1745, published on Mar. 15, 2001 by Japan Institute of Invention and Innovation). Further, the dope solution of cellulose acylate of the invention is usually subjected to solution condensation and filtration, which are similarly described in detail in p 25 of KOKAI-GIHO (Disclosure of Techniques) (Kogi No. 2001-1745, published on Mar. 15, 2001 by Japan Institute of Invention and Innovation). In this connection, when dissolution is carried out a thigh temperatures, in most cases the temperature is not lower than the boiling point of a solvent used and the solvent is used under pressurized conditions.

As for the cellulose acylate solution, a preferable solution has a viscosity and a dynamic storage elastic modulus within a range described below from the viewpoint of easy casting. Measurement is carried out by applying 1 mL of a sample solution to a rheometer (CLS 500) with a Steel Cone having diameter of 4 cm/2° (both are manufactured by TA Instruments). Such measurement condition is employed that measurement is carried out within a range of 40° C. -−10° C. while varying at 2° C./min of Oscillation Step/Temperature Ramp to give a static non-Newtonian viscosity n* (Pa·s) at 40° C. and a storage elastic modulus G′ (Pa) at −5C. Here, before starting the measurement, the sample solution is kept warm at a temperature for starting the measurement till the solution temperature becomes constant. In the invention, viscosity of 1-400 Pa·s at 40° C. and a dynamic storage elastic modulus of 500 Pa or more at 15° C. are preferred, and viscosity of 10-200 Pa·s at 40° C. and a dynamic storage elastic modulus of 100-1,000,000Pa at15° C. are more preferred. Further, a greater dynamic storage elastic modulus at low temperature is more preferred. For example, when a casting support is at −5° C., a dynamic storage elastic modulus is preferably 10,000-1,000,000 Pa at −5° C., and when the support is at −50° C., a dynamic storage elastic modulus is preferably 10,000-5,000,000 Pa at −50° C.

In the invention, since the aforementioned specific cellulose acylate is employed, it is the characteristic that a dope of a high concentration can be obtained, thereby giving a cellulose acylate solution having a high concentration and, further, excellent stability without relying on such means as condensation. In order to achieve easier dissolution, a solution having a lower concentration may be first prepared, which is then condensed with some condensation means. Although there is not particular restriction to the condensation method, for example, such methods can be employed as leading a low concentration solution between a tube and a rotating locus of a periphery of rotor blade rotating in the circumferential direction in the tube and giving temperature difference between the solution and the system to evaporate the solvent and obtain a high concentration solution (for example, JP-A-4-259511 etc.); and injecting a heated low concentration solution from a nozzle into avessel, flash-evaporating the solvent during staying time of the solution between the nozzle and the vessel interior wall and, at the same time, extracting the solvent vapor from the vessel and extracting a high concentration solution from the vessel bottom (for example, methods as described in U.S Pat. Nos. 2,541,012, 2,858,229, 4,414,341, 4,504,355 etc.).

Prior to casting, the solution is preferably filtered and removed of foreign material such as an undissolved material, dirt and impurities using an appropriate filter element such as a metal mesh and filtering cloth. For filtration of the cellulose acylate solution, use of a filter having an absolute filtration accuracy of 0.1-100 μm is preferred, and use of a filter having an absolute filtration accuracy of 0.5-25 μm is more preferred. Thickness of the filter is preferably 0.1-10 mm, more preferably 0.2-2 mm. In that case, filtration pressure is preferably 1.6 MPa or less, more preferably 1.2 MPa or less, further preferably 1.0 MPa or less, and filtration under 0.2 MPa or less is particularly preferred. As for an filter element, conventionally publicly know materials can be preferably used, including glass fiber, cellulose fiber, paper filter and fluorocarbon resin such as tetrafluoroethylene, and the like. Particularly, ceramics, metal and the like are preferably used. The cellulose acylate solution just before film-forming may have a viscosity in a range that allows casting to be performed upon film-forming. Usually, preparation in a range of 10 Pa·s-2000 Pa·s is preferred, 30 Pa·s-1000 Pa·s is more preferred, and 40 Pa·s-500 Pa·s is further preferred. Temperature at that time is not particularly restricted when it is a temperature at the casting, but it is preferably −5-+70° C., more preferably −5-+55° C.

[Film-forming]

The cellulose acylate film of the invention can be obtained by carrying out film-forming by using the aforementioned cellulose acylate solution. As for a film-forming method and equipment, a solution casting film-forming method and a solution casting film-forming apparatus conventionally provided for production of cellulose triacetate film are used. Dope (cellulose acylate solution) prepared in a dissolving machine (caldron) is once stored in a storage caldron and defoamed of foam included in the dope to manufacture a final preparation. The dope is sent from a dope discharge port to a pressurized die through, for example, a pressurized metering gear pump capable of metering feed at a high accuracy by rotation rate, which is uniformly cast from a slit of the pressurized die onto a metal support of casting section that is running endlessly. Then, at a striping point where the metal support has gone approximately one round, a half-dried dope film (also referred to as web) is stripped off the metal support. The resulting web is pinched with clips at both ends thereof, conveyed by a tenter while retaining the width of the film and dried, and then conveyed by a group of rolls of a drying apparatus to finish drying and wound by a winder in a designed length. Combination of a tenter and a drying apparatus of a group of rolls depends on purpose thereof. In a solution casting film-forming method used for manufacturing a functional protective film for electronic display, in addition to a solution casting film-forming apparatus, a coating apparatus is often added for surface processing of the film such as an under-coating layer, an antistatic layer, an antihalation layer and a protective layer. Hereinafter, respective production processes are briefly described, but are not restricted to these.

First, upon manufacturing a cellulose acylate film by a solution casting method, a prepared cellulose acylate solution (dope) is cast on a dram or a band, from which the solvent is evaporated to form a film. Concentration of the dope before the casting is preferably adjusted so that solid content thereof is 5-40% by mass. Surface of the dram or the band is preferably of mirror finish. The dope is preferably cast on a dram or a band having a surface temperature of 30° C. or less, and in particular, a metal support temperature of −10-20° C. is preferred. Further, the invention can use such methods as described in JP-A-2000-301555, JP-A-2000-301558, JP-A-07-032391, JP-A-03-193316, JP-A-05-086212, JP-A-62-037113, JP-A-02-276607, JP-A-55-014201, JP-A-02-111511 and JP-A-02-208650.

[Multi-layer Casting]

The cellulose acylate solution may be cast as a single layer solution, or plural cellulose acylate liquids for 2 layers or more maybe cast, on a smooth band or a dramas a metal support. When plural cellulose acylate solutions are cast, respective solutions containing cellulose acylate may be cast from casting ports arranged at some intervals in the traveling direction of the metal support while forming a laminated film. Such methods as described, for example, in JP-A-61-158414, JP-A-1-122419 and JP-A-11-198285 can be applied. Further, cellulose acylate solutions may be cast from 2 casting ports to form a film, which can be practiced according to such methods as described, for example, in JP-B-60-27562, JP-A-61-94724, JP-A-61-947245, JP-A-61-104813, JP-A-61-158413 an JP-A-6-134933. Furthermore, a cellulose acylate film casting method described in JP-A-56-162617 may be employed, in which flow of a high viscosity cellulose acylate solution is enveloped by a low viscosity cellulose acylate solution, and the high and low viscosity cellulose acylate solutions are excluded simultaneously. Furthermore, an embodiment described in JP-A-61-94724 and JP-A-61-94725, in which an outer solution contains more amount of an alcohol component being a poor solvent than an inner solution, is also preferred. Alternatively, by using 2 casting ports, a film may be formed by molding a film on a metal support by a first casting port, striping the film, and performing a second casting on the side of the film having contacted with the metal support surface. Such method is described, for example, in JP-B-44-20235. Cellulose acylate solutions to be cast may be the same solutions or different solutions, without particular restriction. In order to make plural cellulose acylate layers have some functions, respective solutions corresponding to the function may be excluded from respective casting ports. In addition, a cellulose acylate solution may also be simultaneously cast with solutions for other functional layers (such as an adhesion layer, a dye layer, an antistatic layer, an antihalation layer, a UV-absorbing layer and a polarizing film).

When a conventional liquid for a single layer was used, it was necessary to exclude a cellulose acylate solution having a high concentration and viscosity in order to achieve a designed film thickness, and in that case, such troubles often occurred as spots and poor planarity due to generation of solid matters resulting from poor stability of a cellulose acylate solution. In order to solve the problem, plural cellulose acylate solutions are cast from casting ports to make it possible to simultaneously exclude high viscosity solutions onto a metal support, thereby achieving not only manufacture of a film having an improved plane property of good planarity, but also reduction of a drying load due to use of a condensed cellulose acylate solution to allow production speed of a film to be increase. In the case of co-casting, inside and outside thicknesses are not particularly restricted, but the outside is preferably 1-50%, more preferably 2-30% of the total film thickness. Here, in the case of co-casting of 3 layers or more, the thickness of the outside is defined as the total film thickness of the layer contacting with the metal support and the layer contacting with the air side. In the case of co-casting, casting of cellulose acylate solutions containing different concentrations of such additives as the a forementioned plasticizer, UV absorbent and matting agent may be also possible to form a cellulose acylate film having an laminated structure. For example, a cellulose acylate film having such structure as skin layer/core layer/skin layer can be manufactured. For example, a matting agent can be incorporated in a skin layer in an large amount, or only in a skin layer. A plasticizer and a UV absorbent may be incorporated in a large amount in a core layer than in a skin layer, or only in a core layer. Further, types of a plasticizer and a UV absorbent can be altered in a core layer and a skin layer. For example, it is also possible to incorporate at least either one of a low volatile plasticizer and UV absorbent in a skin layer, and add a plasticizer excellent in plastic property or a UV absorbent excellent in ultraviolet-absorbing property in a core layer. Further, addition of a stripping accelerator only in a skin layer on the metal support side is also a preferable embodiment. Addition of an alcohol as a poor solvent in a larger amount in a skin layer than in a core layer is also preferred in order to chill the metal support by a chilled dram method to form gel of the solution. Tgs of a skin layer and a core layer may be different from each other, and Tg of a core layer lower than Tg of a skin layer is preferred. Viscosity of a solution containing cellulose acylate at castingmaybe different between a skin layer and a core layer. In this case, a lower viscosity of skin layer than viscosity of core layer is preferred, but a lower viscosity of core layer than viscosity of skin layer may be allowable.

[Casting]

As for a casting method of the solution, there are such methods as uniformly excluding a prepared dope from a pressurized die onto a metal support, using an doctor blade to adjust a film thickness of the dope once cast on a metal support by a blade, and using a reverse roll coater to adjust it by a roll rotating in a reverse direction. The method using a pressurized die is preferred. Examples of the pressurized die include a coat hanger type, a T-die type and the like, all of which can be used preferably. In addition to methods mentioned here, the casting can be carried out by various conventionally known methods of casting and film-forming a cellulose triacetate solution, thereby giving the same effect as described in respective gazettes, by setting respective conditions while considering differences in boiling points of solvents used and the like. As a metal support running endlessly for use in producing the cellulose acylate film of the invention, a dram, whose surface has been mirror finished by chrome plating, or a stainless belt (or a band), which has been mirror finished by surface polishing, can be used. One or more of pressurized dies for use in producing the cellulose acylate film of the invention may be disposed on the upper side of the metal support. Preferably, the number of the pressurized die is one or two. When two or more of them are disposed, the amount of dope to be cast may be divided to respective dies at various ratios, or the dope may be sent to dies by plural accurate metering gear pumps at respective ratios. Temperature of the cellulose acylate solution used for casting is preferably −10-55° C, more preferably 25-50° C. In that case, all the steps may have the same temperature, or each of steps may have different temperatures. In the latter case, achievement of a designed temperature just before the casting is sufficient.

[Drying]

There are many methods for drying the dope on a metal support responsible for producing the cellulose acylate film, including such methods as blowing hot wind generally from the front face side of the metal support (dram or belt), that is, the front face of web on a metal support, blowing hot wind from the rear face of a dram or belt, and a liquid heat transfer method in which a temperature-controlled liquid is contacted to a belt or dram from the rear face thereof that is the opposite side of the dope casting face to heat the dram or belt through heat transfer and control the surface temperature. Among them, a liquid heat transfer system from the rear face is preferred. Surface temperature of a metal support before the casting may be arbitrary only when it does not exceed the boiling point of a solvent used for the dope. However, in order to accelerate drying and cause flowability on the metal support to be absent, preferably the temperature is set at a temperature lower by 1-10° C. than the boiling point of a solvent having the lowest boiling point among solvents used. Incidentally, when the cast dope is stripped without chilling and drying, this is not applied.

[Stretching]

The retardation of the cellulose acylate film of the invention can be adjusted by a stretching treatment. Further, there are such methods as stretching the film in width direction intentionally, which are described, for example, in JP-A-62-115035, JP-A-4-152125, JP-A-4-284211, JP-A-4-298310, JP-A-11-48271 and the like. This stretching is carried out in order to make an in-plane retardation of the cellulose acylate film higher.

Stretching of a film is practiced under ordinary temperature or heated conditions. Heated temperature is preferably in a range of +10° C. across the glass transition temperature of the film. The filmmaybe stretched by a uniaxial drawing or by a simultaneous or sequential biaxial drawing. Range of the stretching is 10-200%. Range of the stretching is preferably 1-100%, particularly preferably 1-80%. The refraction index of an optical film in width direction is preferably greater than the refraction index in length direction and therefore the stretching ratio in width direction is preferably larger than that in length direction. The stretching may be carried out in the middle of a film-forming step, or a rolled web having been film-formed and wound may be subjected to a stretching treatment. In the former case, stretching is preferably carried out under a state of presence of a residual solvent, wherein the stretching can be preferably carried out at a residual solvent volume (wet ratio, residual solvent amount/(residual solvent amount+solid content)) of 2-50%.

In order to improve chromatic dispersion of Re and Rth, the film stretching is preferably carried out at a temperature higher than the glass transition temperature by 30-100° C., more preferably 35-90° C., most preferably 40-80° C.

By setting the stretching temperature of the film to be higher than the glass transition temperature by 30° C.-100° C., it is possible to approximate the wavelength dispersion property of Re to inverse dispersion (Re₍₄₀₀₎<Re₍₇₀₀₎), and the wavelength dispersion property of Rth to forward dispersion (Rth₍₄₀₀₎>Rth₍₇₀₀₎). Accordingly, it is possible to improve the view angle, contrast and hue alteration of black when it is mounted to a liquid crystal display device.

(Cyclic polyolefin)

Next, detailed description will be given about cyclic polyolefin preferably used in the invention. In the invention, 2 or more types of cyclic polyolefins may be used in combination.

The cyclic polyolefin in the invention has a structure formed by polymerization of cyclic olefin. Examples of the cyclic polyolefin include (1) norbornene-based polymer, (2) polymer of a monocyclicolefin, (3) polymer of acyclic conjugated diene, (4) polymer of a vinylalicyclic hydrocarbon, and hydrides of (1)-(4). Examples of the cyclic polyolefins preferably used in the invention include addition (co)polymers comprising at least one repeating unit represented by the following formula (II), addition (co)polymers comprising at least one repeating unit represented by the following formula (II) and at least one repeating unit represented by the following formula (I), and ring-opened (co)polymers comprising at least one repeating unit represented by the following formula (III). 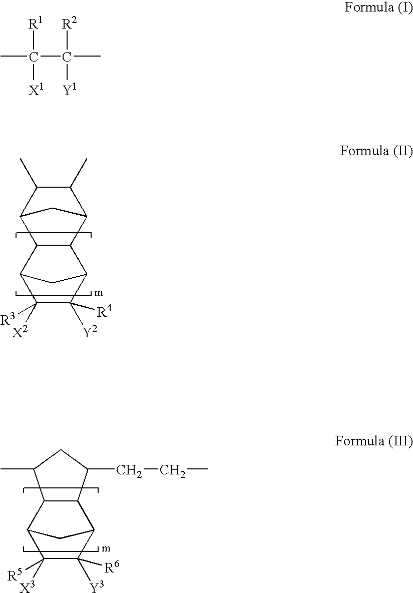
wherein m represents an integer of 0-4; R¹-R⁶ each independently represents a hydrogen atom or a hydrocarbon group having 1-10 carbon atoms;
X¹-X³ and Y¹-Y³ each independently represents a hydrogen atom or a hydrocarbon group having 1-10 carbon atoms, a halogen atom, a hydrocarbon group having 1-10 carbon atoms substituted by a halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW; or X¹ and Y¹, X² and Y², or X³ and Y³ may be taken together to form —COOCO— or —CONR¹⁵CO—. R¹¹-R¹⁵ each independently represents a hydrogen atom or a hydrocarbon group having 1-20 carbon atoms, Z represents a hydrocarbon group or a hydrocarbon group substituted by a halogen, W represents SiR¹⁶ₚD₃₋ₚ (R¹⁶ represents a hydrocarbon group having 1-10 carbon atoms, D represents a halogen atom, —OCOR¹⁶ or —OR¹⁶, and p represents an integer of 0-3), and n represents an integer of 0-10.

By introducing a functional group having a large polarizability in a substituent of X¹-X³ and Y¹-Y³, it is possible to make retardation of the thickness direction (Rth) of an optical film large, and generation possibility of in-plane retardation (Re) higher. With regard to a film having a high Re generation possibility, the Re value can be made large by stretching the film in a film-forming process.

As a norbornene-based addition (co)polymer, those disclosed in JP-A-10-7732, JP-T-2002-504184 (the term “JP-T” as used herein means a published Japanese translation of a PCT patent application), U.S. Patent Application Publication No. 2004/229157 A1 and International Publication No. 2004/070463 A1 pamphlet can be used. A norbornene-based addition (co)polymer can be obtained by addition-polymerizing norbornene-based polycyclic unsaturated compounds with each other. Further, according to need, it is obtained by addition-polymerizing a norbornene-based polycyclic unsaturated compound with ethylene, propylene, butene, a conjugated diene such as butadiene or isoprene; nonconjugated diene such as ethylidenenorbornene; or a linear diene compound such as acrylonitrile, acrylic acid, methacrylic acid, maleic acid anhydride, acrylic acid ester, methacrylic acid ester, maleimide, vinyl acetate or vinyl chloride. As a norbornene-based addition (co) polymer, a commercially available product may be also used. Specific examples include APL8008T (Tg 70° C.), APL6013T (Tg 125° C.) and-APL6015T (Tg145° C.) marketed by Mitsui Chemicals, Inc., pellets such as TOPAS8007, TOPAS6013 and TOPAS6015 marketed by Polyplastics Co., Ltd., and Appear3000 marketed by Ferrania Co.

Norbornene-based polymer hydride can be obtained by addition-polymerizing or metathesis ring-opening polymerizing a polycyclic unsaturated compound followed by hydrogen addition, as disclosed in the gazette such as JP-A-1-240517, JP-A-7-196736, JP-A-60-26024, JP-A-62-19801, JP-A-2003-1159767, or JP-A-2004-309979.

In the formula (III), preferable R⁵ and R⁶ is each independently a hydrogen atom or —CH₃, and preferable X³ and Y³ is each independently a hydrogen atom, Cl or —COOCH₃. As to such preferable norbornene-based resin, a commercially available product can be also used. Specific examples thereof include Arton G and Arton F marketed by JSR Corporation, and Zeonor ZF14, Zeonor ZF16, Zeonex 250 and Zeonex 280 marketed by ZEON Corporation.

The cyclic polyolefin for use in the invention has a mass average molecular weight (Mw) measured with gel permeation chromatography (GPC) of preferably 5,000-1,000,000, more preferably 10,000-500,000, and further preferably 50,000-300,000, in terms of polystyrene molecular weight. Further, it has molecular weight distribution (Mw/Mn; Mn is a number average molecular weight measured with GPC) of preferably 10 or less, more preferably 5.0 or less, and further preferably 3.0 or less. The glass transition temperature (Tg) measured with a DSC is preferably 50-350° C., more preferably 80-330° C., and further preferably 100-300° C.

With regard to a manufacturing method of a film using cyclic polyolefin and additive components on that occasion, and the application ofthe manufactured film, the above description about cellulose acylate can be referred to.

### EXAMPLES

Hereinafter, the characteristics of the present invention will be described more specifically on the basis of Examples and Comparative Examples. Material, use quantity, percentage, treatment content, treatment procedure and the like shown in the following Examples can be arbitrarily changed within a range that does not result in deviation from the purpose of the invention. Accordingly, the scope of the invention should not be construed restrictively by specific examples shown below.

### Examples 1-5, Comparative Examples 1-2

(1) Manufacture of a Transparent Film for a Protective Film (1-1) Manufacture of a Transparent Film Sample 101

100 parts by mass of cellulose acetate with an acetyl substitution degree of 2.86, a substitution degree for an acyl group having 3 or more carbon atoms of 0.0 and an acyl substitution degree at the 6-position/total substitution degree of 0.317, 10 parts by mass of triphenyl phosphate (TPP), 400 parts by mass of methylene chloride (first solvent) and 60 parts by mass of methanol (second solvent) were respectively put in amixing tank and stirred to dissolve, thereby preparing a cellulose acetate solution. The cellulose acetate solution was filtrated, which was cast on a metal substrate, held and conveyed in a tenter zone at 100° C., and passed through a drying zone at 130° C. for 30 minutes to dry, thereby manufacturing a transparent film sample 101. The formed transparent film 101 had a residual solvent quantity of 0.2% or less, and a thickness of 40 μm.

(1-2) Manufacture of a Transparent Film Sample 102

A transparent film sample 102 having a thickness of 50 μm was manufactured by using the cellulose acetate solution used for manufacturing the transparent film sample 101 in the same way as in the sample 101 except for altering the film thickness at casting.

(1-3) Manufacture of a Transparent Film Sample 103

A transparent film sample 103 having a thickness of 70 μm was manufactured by using the cellulose acetate solution used for manufacturing the transparent film sample 101 in the same way as in the sample 101 except for altering the film thickness at casting.

(1-4) Manufacture of a Transparent Film Sample 104

A transparent film sample 104 having a thickness of 80 μm was manufactured by using the cellulose acetate solution used for manufacturing the transparent film sample 101 in the same way as in the sample 101 except for altering the film thickness at casting.

(2) Manufacture of a Polarizing Plate

The above-described transparent film samples 101-104 were dipped in an aqueous 1.5 mol/L sodium hydroxide solution at 55° C. for 2 minutes, washed in an water washing bath at room temperature, and then neutralized using 0.1 mol/L sulfuric acid at 30° C. They were washed again in a water washing bath at room temperature, and then dried with hot air at 100° C. Thus, the surface of respective transparent film samples was surface-treated.

A polarizer having a thickness of 25 pim was obtained by continuously stretching a polyvinyl alcohol film having a thickness of 80 μm in a roll shape by 5 times and drying the same.

A foreside (viewer side) iodine-based polarizing plate was manufactured by bonding each of above-mentioned surface-treated transparent film samples 101-104 as a protective film on both sides of a polarizer having a thickness of 25 μm in a constitution shown in Table 1 using a polyvinyl alcohol-containing adhesive. On the other hand, a backside (backlight side) iodine-based polarizing plate was manufactured by bonding the above-mentioned surface-treated transparent film sample 104 (thickness 80 μm) as a protective film on both sides of a polarizer having a thickness of 25 ptm using a polyvinyl alcohol-containing adhesive.

(3) Manufacture of a Liquid Crystal Display Device

On the foreside and backside of an IPS type liquid crystal cell having 26-inch size (lateral longer side of 58 cm, vertical shorter side of 35 cm) using a glass substrate having a thickness of 0.5 mm, the polarizing plate was bonded so as to contact with the substrate via an acrylic sticking agent in a constitution shown in Table 1 to manufacture a liquid crystal panel. The liquid crystal panel was housed in a housing to manufacture a liquid crystal display device (FIG. 1). It was previously checked that the elasticity of the adhesive and the sticking agent used on that occasion showed little difference in the longer side direction and in the shorter side direction, and that the elasticity had a value of negligible magnitude compared with other members.

Upon manufacturing respective liquid crystal display devices, respective members were arranged so that the polarizer absorption axis of the polarizing plate constituting the foreside laminated body, the machine conveying direction of the protective film constituting the foreside laminated body and the longer side direction of the panel were parallel with one another; the polarizer absorption axis of the polarizing plate constituting the backside laminated body and the machine conveying direction of the protective film constituting the backside laminated body were parallel with each other; and that the absorption axis of the polarizing plate constituting the foreside laminated body and the absorption axis of the polarizing plate constituting the backside laminated body were perpendicular with each other.

(4) Evaluation of the Liquid Crystal Display Device by a Moist Heat Treatment

The manufactured liquid crystal display device was left under an environment of temperature 50° C. and relative humidity 95% for 50 hours. After the treatment, it was directly moved in an environment of temperature 25° C. and relative humidity 60%. It was powered on, and the state of black level display was observed visually. Next, only the panel was taken out of the liquid crystal display device, and moved under an environment of temperature 25° C. and relative humidity 60%. After a time laps of 20 minutes, the warpage quantity w was measured. The warpage quantity w was divided by the length in the longer side direction L to give a warpage ratio w/L (mm/mm). The result is shown in Table 1.

TABLE 1

| | Protective layer on | | Protective layer on | | |
|---|---|---|---|---|---|
| | viewer side | | subtrate side of | | |
| | of foreside polarizing | | foreside polarizing | | Warpage |
| | plate | | plate | | ratio |
| | Transparent | Thickness | Transparent | Thickness | w/L |
| | film No. | (μm) | film No. | (μm) | (mm/mm) |
| Ex. 1 | 104 | 80 | 101 | 40 | 0.0047 |
| Ex. 2 | 104 | 80 | 102 | 50 | 0.0048 |
| Ex. 3 | 104 | 80 | 103 | 70 | 0.0055 |
| Ex. 4 | 103 | 70 | 101 | 40 | 0.0048 |
| Ex. 5 | 104 | 70 | 102 | 50 | 0.0049 |
| Comp. | 104 | 80 | 104 | 80 | 0.0062 |
| Ex. 1 | | | | | |
| Comp. | 102 | 50 | 104 | 80 | 0.0065 |
| Ex. 2 | | | | | |

### Examples 6-10, Comparative Examples 3-4

5 (1) Preparation of Cellulose Acylate

A cellulose acylate, wherein the acetyl substitution degree (A) was 1.9, the substitution degree (B) for acyl groups having 3 or more carbon atoms was 0.8 [all of the acyl group having 3 or more carbon atoms were propionyl groups, thus B was equal to the propionyl substitution degree], the acyl substitution degree at the 6-position was 0.897 and the acyl substitution degree at the 6-position/total substitution degree were 0.332, was prepared. That is, to cellulose, sulfuric acid was added as a catalyst (7.8 parts by mass relative to cellulose 100 parts by mass), and a carboxylic acid to be a raw material of an acyl substituent were added, to carry out an acylation reaction at 40° C. At that time, by adjusting the quantity of the sulfuric acid catalyst, the quantity of moisture and the ripening time, the type of the substituting acyl group, the total substitution degree and the substitution degree at the 6-position were adjusted. The ripening was carried out at 40° C. Further, after the acylation, ripening was carried out at 40° C.

Furthermore, low molecular weight components of the cellulose acylate were removed by washing with acetone.

(2) Preparation of a Dope

(2-1) Cellulose Acylate Solution

The following composition was put in a mixing tank and stirred to dissolve respective components, and further heated at 90° C. for about 10 minutes, which was then filtrated with a filter paper having an average pore size of 34 μm and a sintered metal filter having an average pore size of 10 μm.

(Composition of the Cellulose Acylate Solution)

| | | |
|---|---|---|
| Cellulose acylate prepared in (1) | 100.0 | parts by mass |
| Triphenylphosphate | 8.0 | parts by mass |
| Biphenyldiphenylphosphate | 4.0 | parts by mass |
| Methylenechloride | 403.0 | parts by mass |
| Methanol | 60.2 | parts by mass |

(2-2) Dispersion Liquid of Matting Agent

Next, the following composition containing the cellulose acylate solution prepared by the above-described method was put in a dispersing machine to prepare a dispersion liquid of a matting agent.

(Composition of a dispersion liquid of a matting agent)

| | | |
|---|---|---|
| Silica particles (average particle diameter of | 2.0 | parts by mass |
| 16 nm; “aerosil R972” manufactured by | | |
| NIPPON AEROSIL CO., LTD.) | | |
| Methylenechloride | 72.4 | parts by mass |
| Methanol | 10.8 | parts by mass |
| Above-described cellulose acylate solution | 10.3 | parts by mass |

(2-3) Retarder Solution A

Next, the following composition containing the cellulose acylate solution manufactured by the above-described method was put in a mixing tank, which was stirred and dissolved with heating to prepare a retarder solution A.

(Composition of the Retarder Solution A)

| | | |
|---|---|---|
| Retarder (RP1 having the following structure) | 20.0 | parts by mass |
| Methylenechloride | 58.3 | parts by mass |
| Methanol | 8.7 | parts by mass |
| Above-described cellulose acylate solution | 12.8 | parts by mass |

100 parts by mass of the above-described cellulose acylate solution, 1.35 parts by mass of the dispersion liquid of the matting agent and further 3 parts by mass of the retarder solution A were mixed to prepare a dope for film-forming. The dope was offered to manufacture a film. The retarder solution A had a composition shown by parts by mass of the retarder relative to 100 parts by mass of the cellulose acylate. 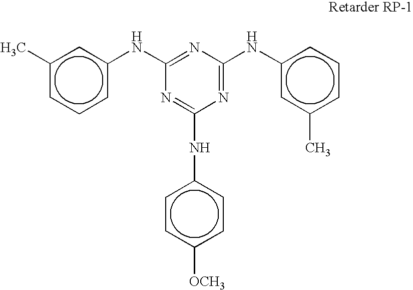
(3) Manufacture of a Transparent Film for a Protective Film

The above-described dope was cast using a band casting machine. A film peeled off the band in such state as a residual solvent quantity of 25-35% by mass was stretched in the machine direction and the width direction using a tenter, while controlling the stretching temperature within a range from lower by about 5° C. to higher by about 5° C. relative to the glass transition temperature of the cellulose acylate film, to form a cellulose acylate film having a thickness of 40 μm. It was referred to as a transparent film sample 201.

By carrying out the same procedure while altering the film thickness at casting, a transparent film sample 202 having a thickness of 50 μm, a transparent film sample 203 having a thickness of 70 μm and a transparent film sample 204 having a thickness of 80 μm were manufactured respectively.

(4) Manufacture of a Polarizing Plate and a Liquid Crystal Display Device

The above-mentioned transparent film samples 201-204were used as described in Table 2 to prepare polarizing plates in the same way as in Examples 1-5, and further liquid crystal display devices were manufactured.

(5) Evaluation of the Liquid Crystal Display Device by a Moist Heat Treatment

For the prepared liquid crystal display devices, the warpage ratio w/L (mm/mm) was obtained using the same way as in Examples 1-5. The result is listed in Table 2.

TABLE 2

| | Protective layer on | | Protective layer on | | |
|---|---|---|---|---|---|
| | viewer side | | substrate side of | | |
| | of foreside polarizing | | foreside polarizing | | Warpage |
| | plate | | plate | | ratio |
| | Transparent | Thickness | Transparent | Thickness | w/L |
| | film No. | (μm) | film No. | (μm) | (mm/mm) |
| Ex. 6 | 204 | 80 | 201 | 40 | 0.0046 |
| Ex. 7 | 204 | 80 | 202 | 50 | 0.0047 |
| Ex. 8 | 204 | 80 | 203 | 70 | 0.0054 |
| Ex. 9 | 203 | 70 | 201 | 40 | 0.0047 |
| Ex. 10 | 204 | 70 | 202 | 50 | 0.0048 |
| Comp. | 204 | 80 | 204 | 80 | 0.0061 |
| Ex. 3 | | | | | |
| Comp. | 202 | 50 | 204 | 80 | 0.0064 |
| Ex. 4 | | | | | |

### Examples 11-15, Comparative Examples 5-6

(1) Preparation of Cellulose Acylate

A cellulose acylate, wherein the acetyl substitution degree (A) was 1.4, the substitutiondegree (B) foranacyl group having 3 or more carbon atoms was 1.3 [all of the acyl group

| | | |
|---|---|---|
| Cellulose acylate prepared in (1) | 100.0 | parts by mass |
| Triphenylphosphate | 8.0 | parts by mass |
| Biphenyldiphenylphosphate | 4.0 | parts by mass |
| Methylenechloride | 403.0 | parts by mass |
| Methanol | 60.2 | parts by mass |

having 3 or more carbon atoms were butanoyl groups, thus B was equal to the butanoyl substitution degree], the acyl substitution degree at the 6-position was 0.880 and the acyl substitution degree at the 6-position/total substitution degree were 0.326, was prepared. That is, to cellulose, sulfuric acid was added as a catalyst (7.8 parts by mass relative to cellulose 100 parts by mass), and carboxylic acid to be a raw material of an acyl substituent was added, to carry out an acylation reaction at 40° C. At that time, by adjusting the quantity of the sulfuric acid catalyst, the quantity of moisture and the ripening time, the type of the substituting acyl group, the total substitution degree and the substitution degree of hydrogen atom of 6-hydroxyl group were adjusted. The ripening was carried out at 40° C. Further, after the acylation, ripening was carried out at 40° C. Furthermore, low molecular weight components of the cellulose acylate were removed by washing with acetone.

(2) Preparation of a Dope

(2-1) Cellulose Acylate Solution

The following composition was put in a mixing tank and stirred to dissolve respective components, and further heated at 90° C. for about 10 minutes, which was then filtrated with a filter paper having an average pore size of 34 μm and a sintered metal filter having an average pore size of 10 μm.

(Composition of the Cellulose Acylate Solution)

(2-2) Dispersion Liquid of a Matting Agent

Next, the following composition containing the cellulose acylate solution prepared by the above-described method was put in a dispersing machine to prepare a dispersion liquid of a matting agent.

(Composition of a dispersion liquid of a matting agent)

| | | |
|---|---|---|
| Silica particles (average particle diameter of | 2.0 | parts by mass |
| 16 nm; “aerosil R972” manufactured by | | |
| NIPPON AEROSIL CO., LTD.) | | |
| Methylenechloride | 72.4 | parts by mass |
| Methanol | 10.8 | parts by mass |
| Above-described cellulose acylate solution | 10.3 | parts by mass |

(Composition of the retarder solution A)

| | | |
|---|---|---|
| Retarder (RP1) | 20.0 | parts by mass |
| Methylenechloride | 58.3 | parts by mass |
| Methanol | 8.7 | parts by mass |
| Above-described cellulose acylate solution | 12.8 | parts by mass |

(2-3) Retarder Solution A

Next, the following composition containing the cellulose acylate solution manufactured by the above-described method was put in a mixing tank, which was stirred and dissolved with heating to prepare a retarder solution A.

100 parts by mass of the above-mentioned cellulose acylate solution, 1.35 parts by mass of the dispersion liquid of the matting agent and further 3 parts by mass of the retarder solution A were mixed to prepare a dope for film-forming. The dope was offered to manufacture a film. The retarder solution A had a composition shown by parts by mass of the retarder relative to 100 parts by mass of the cellulose acylate.

(3) Manufacture of a Transparent Film for a Protective Film

The above-mentioned dope was cast using a band casting machine. A film peeled off the band in such state as a residual solvent quantity of 25-35% by mass was stretched in the machine direction and the width direction using a tenter, while controlling the stretching temperature within a range from lower by about 5° C. to higher by about 5° C. relative to the glass transition temperature of the cellulose acylate film, to form a cellulose acylate film having a thickness of 40 μm. It was referred to as a transparent film sample 301.

By carrying out the same procedure while altering the film thickness at casting, a transparent film sample 302 having a thickness of 50 μm, a transparent film sample 303 having a thickness of 70 μm and a transparent film sample 304 having a thickness of 80 μm were manufactured respectively. ps (4) Manufacture of a Polarizing Plate and a Liquid Crystal Display Device

The above-mentioned transparent film samples 301-304 were used as described in Table 3 to prepare polarizing plates in the same way as in Examples 1-5, and further liquid crystal display devices were manufactured.

(5) Evaluation of the Liquid Crystal Display Device by a Moist Heat Treatment

For the prepared liquid crystal display devices, the warpage ratio w/L (mm/mm) was obtained using the same way as in Examples 1-5. The result is listed in Table 3.

TABLE 3

| | Protective layer on | | Protective layer on | | |
|---|---|---|---|---|---|
| | viewer side | | substrate side of | | |
| | of foreside polarizing | | foreside polarizing | | Warpage |
| | plate | | plate | | ratio |
| | Transparent | Thickness | Transparent | Thickness | w/L |
| | film No. | (μm) | film No. | (μm) | (mm/mm) |
| Ex. 11 | 304 | 80 | 301 | 40 | 0.0046 |
| Ex. 12 | 304 | 80 | 302 | 50 | 0.0047 |
| Ex. 13 | 304 | 80 | 303 | 70 | 0.0054 |
| Ex. 14 | 303 | 70 | 301 | 40 | 0.0047 |
| Ex. 15 | 304 | 70 | 302 | 50 | 0.0048 |
| Comp. | 304 | 80 | 304 | 80 | 0.0061 |
| Ex. 5 | | | | | |
| Comp. | 302 | 50 | 304 | 80 | 0.0064 |
| Ex. 6 | | | | | |

### Example 16

Each of cycloolefin polymer film sample 401 (ZEONOR film, thickness 100 μm), sample 402 (ZEONOR film, thickness 84 μm) and sample 403 (ZEONOR film, thickness 70 μm), manufactured by ZEON CORPORATION, was subjected to a corona treatment to be a viewer side protective film. Then the corona treated-face side was adhered on one side of the polarizer manufactured in the same way as in Examples 1-5 using a polyvinyl alcohol-containing adhesive. Further, each of the cellulose acetate film samples 101, 102, 103, 104 (substrate side protective film) having been subjected to a saponification treatment in the same way as in Examples 1-5 was adhered to the other face of the polarizer using the same adhesive to manufacture the viewer side polarizing plate (foreside laminated body) listed in Table 4. Using the above-described viewer side polarizing plate, a liquid crystal display device was manufactured in the same way as in Example 1, which was evaluated. The result is shown in Table 4.

TABLE 4

| | | | Protective layer on | | |
|---|---|---|---|---|---|
| | Protective layer on | | substrate side of | | |
| | viewer side of foreside | | foreside polarizing | | Warpage |
| | polarizing plate | | plate | | ratio |
| | Transparent | Thickness | Transparent | Thickness | w/L |
| | film No. | (μm) | film No. | (μm) | (mm/mm) |
| Ex. 16 | 401 | 100 | 101 | 40 | 0.0001 |
| Ex. 17 | 401 | 100 | 102 | 50 | 0.0001 |
| Ex. 18 | 401 | 100 | 103 | 70 | 0.0002 |
| Ex. 19 | 401 | 100 | 104 | 80 | 0.0002 |
| Ex. 20 | 402 | 84 | 101 | 40 | 0.0001 |
| Ex. 21 | 402 | 84 | 102 | 50 | 0.0002 |
| Ex. 22 | 402 | 84 | 103 | 70 | 0.0003 |
| Ex. 23 | 403 | 70 | 101 | 40 | 0.0001 |
| Ex. 24 | 403 | 70 | 102 | 50 | 0.0002 |

### Example 25

The cycloolefin polymer film sample 401 (ZEONOR film, thickness 100 μm) manufactured by ZEON CORPORATION was subjected to a coron a treatment. The corona-treated face side was adhered to one face of a polarizer manufactured in the same way as in Example 1 as the viewer side protective film using a polyvinyl alcohol-containing adhesive. Further, the cellulose acetate film sample 104 (thickness 80 pm) having been subjected to saponification treatment in the same way as in Example 1 (substrate side protective film) was adhered to the other face of the polarizer using a similar adhesive. Furthermore, on the cycloolefin polymer film side of the laminated body, a cycloolefin polymer film (ZEONOR film, thickness 84 μm) manufactured by ZEON CORPORATION was laminated via a sticky sheet (SK-1478, manufactured by Soken Chemical & Engineering Co., Ltd.) to manufacture a backside laminated body. A liquid crystal display device was manufactured in the same way as in Example 16 except for using the above-described backside polarizing plate, which was evaluated. As the result, the warpage ratio w/L (mm/mm) was 0.0001.

As is clear from Tables 1-4, it was confirmed that the liquid crystal display devices in Examples 1-25 manufactured by using a protective film having a predetermined thickness and according to a predetermined arrangement had a small warpage of the panel, showed no deterioration of display caused by warpage to be at a level of practically no problem. On the other hand, it was confirmed that liquid crystal display devices in Comparative Examples showed such high warpage ratio of the panel as 0.006 or more, generated corner unevenness due to warpage to be at a level of having substantial problem in actual uses.

The image display device of the invention can effectively inhibit lowering in display performance because warpage of the panel is suppressed. Consequently, it is possible to maintain an excellent display performance even under conditions with significant environmental variation. Accordingly, the invention has a high industrial applicability.

The present disclosure relates to the subject matter contained in Japanese Patent Application No. 217242/2005 filed on Jul. 27, 2005and Japanese Patent Application No. 192039/2006 filed on Jul. 12, 2006, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A polarizing plate comprising a polarizer and at least one each protective film on both sides of the polarizer,
wherein the total thickness of the protective film provided on one side of the polarizer is thinner than the total thickness of the protective film provided on the opposite side of the polarizer by 10 μm or more.

2. A polarizing plate comprising a polarizer, one protective film on one side of the polarizer, and at least one protective film on the opposite side of the polarizer,
wherein the thickness of the one protective film provided on the one side of the polarizer is thinner than the total thickness of the protective film provided on the opposite side of the polarizer by 10 μm or more.

3. The polarizing plate according to claim 1, wherein at least one of the protective films constituting the polarizing plate comprises cellulose acylate.

4. The polarizing plate according to claim 3, wherein the cellulose acylate has a structure in which some or all hydroxyl groups of glucose units constituting cellulose are substituted by at least one acyl group having 2 or more carbon atoms, and satisfies the following formulae (1) and (2):
2.0≦DS₂+DS₃+DS₆≦3.0 Formula (1):
DS₆/(DS₂+DS₃+DS₆)≧0.315 Formula (2):
wherein DS₂ represents the substitution degree of hydrogen atom of 2-hydroxyl group in the glucose units by the acyl group; DS₃ represents the substitution degree of hydrogen atom of 3-hydroxyl group in the glucose units by the acyl group; and DS₆ represents the substitution degree of hydrogen atom of 6-hydroxyl group in the glucose units by the acyl group.

5. The polarizing plate according to claim 4, wherein the acyl group is an acetyl group.

6. The polarizing plate according to claim 3, wherein the protective film comprising cellulose acylate contains cellulose a mixed fatty acid ester of cellulose as a primary polymer component, wherein the mixed fatty acid ester of cellulose has a structure in which hydroxyl groups of cellulose are substituted by an acetyl group and at least one acyl group having 3 or more carbon atoms, and satisfies the following formulae (3) and (4):
2.0≦A+B≦3.0 Formula (3):
0<B Formula (4):
wherein A represents the substitution degree for the acetyl group; and B represents the substitution degree for the acyl group having 3 or more carbon atoms.

7. The polarizing plate according to claim 6, wherein the acyl group having 3 or more carbon atoms is a propionyl group and/or a butanoyl group.

8. The polarizing plate according to claim 6, wherein the substitution degree of hydrogen atom of 6-hydroxyl group in the glucose units of the cellulose acylate is 0.75 or more.

9. The polarizing plate according to claim 1, wherein at least one of protective films constituting the polarizing plate comprises a cyclic polyolefin.

10. The polarizing plate according to claim 1, wherein the total thickness of the protective film on one side of the polarizer is 30 μm-50 μm, and the total thickness of the protective film on the opposite side of the polarizer is 70 μm-150 μm.

11. An image display device comprising a panel including a substrate containing glass or resin, a foreside laminated body arranged on the viewer side of the substrate, and a backside laminated body arranged on the opposite side of the substrate,
wherein the foreside laminated body is the polarizing plate according to claim 1 in which the total thickness of the protective film arranged on the substrate side of the polarizer is thinner than the total thickness of the protective film arranged on the viewer side of the polarizer by 10 μm or more.

12. The image display device according to claim 11, wherein the panel has an oblong or square shape with a side of 10 cm-500 cm.

13. The image display device according to claim 11, wherein the foreside surface of the panel is opened and the backside of the panel is closed by a housing.

14. The image display device according to claim 11, wherein the substrate includes a liquid crystal cell, and the backside laminated body includes an optical compensatory film.

15. The image display device according to claim 11, wherein the device utilizes liquid crystal display mode of a VA system or an IPS system is used.
